(19) United States
(12) Patent Application Publication
(10) Pub. No.: US 2024/0137529 A1
(43) Pub. Date: Apr. 25, 2024

(54) METHOD, DEVICE, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Yang WANG, Beijing (CN); Li ZHANG, Los Angeles, CA (US); Kai ZHANG, Los Angeles, CA (US); Zhipin DENG, Beijing (CN)

(21) Appl. No.: 18/399,574

(22) Filed: Dec. 28, 2023

Related U.S. Application Data
(63) Continuation of application No. PCT/CN2022/102956, filed on Jun. 30, 2022.

(30) Foreign Application Priority Data
Jun. 30, 2021 (WO) PCT/CN2021/104117

(51) Int. Cl. H04N 19/159; H04N 19/105; H04N 19/119; H04N 19/176; H04N 19/189

(52) U.S. Cl. CPC H04N 19/159; H04N 19/105; H04N 19/119; H04N 19/176; H04N 19/189

(57) ABSTRACT

Embodiments of the present disclosure provide a method for video processing. The method comprises: determining, during a conversion between a current video block of a video and a bitstream of the video, at least one target intra prediction mode for the current video block based on neighboring reconstructed samples of the current video block; determining a prediction or a reconstruction of the current video block based on a combination of the at least one target intra prediction mode and one of an inter coding tool or a candidate coding tool, the candidate coding tool being used for determining a reference block for the current video block with samples in a current picture associated with the current video block; and performing the conversion based on the prediction or the reconstruction of the current video. Compare with conventional solutions, the proposed method can advantageously improve coding efficiency and coding quality.

### CROSS REFERENCE TO RELATED APPLICATIONS

This application is a continuation of International Application No. PCT/CN2022/102956, filed on Jun. 30, 2022, which claims the benefit of International Application No. PCT/CN2021/104117 filed on Jul. 1, 2021. The entire contents of these applications are hereby incorporated by reference in their entireties.

### FIELD

Embodiments of the present disclosure relates generally to video coding techniques, and more particularly, to a combination of derived intra modes and an inter coding tool or other coding tools.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally expected to be further improved.

### SUMMARY

In a first aspect, a method for video processing is proposed. The method comprises: determining, during a conversion between a current video block of a video and a bitstream of the video, at least one target intra prediction mode for the current video block based on neighboring reconstructed samples of the current video block; determining a prediction or a reconstruction of the current video block based on a combination of the at least one target intra prediction mode and one of an inter coding tool or a candidate coding tool, the candidate coding tool being used for determining a reference block for the current video block with samples in a current picture associated with the current video block; and performing the conversion based on the prediction or the reconstruction of the current video.

The method in accordance with the first aspect of the present disclosure combines an intra prediction mode derived using previously coded blocks or samples with other coding tools. Thereby, the proposed method can advantageously improve coding efficiency and coding quality.

In a second aspect, an apparatus for processing video data is proposed. The apparatus for processing video data comprising a processor and a non-transitory memory with instructions thereon, wherein the instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by a video processing apparatus. The method comprises: determining at least one target intra prediction mode for a current video block of the video based on neighboring reconstructed samples of the current video block; determining a prediction or a reconstruction of the current video block based on a combination of the at least one target intra prediction mode and one of an inter coding tool or a candidate coding tool, the candidate coding tool being used for determining a reference block for the current video block with samples in a current picture associated with the current video block; and generating the bitstream based on the prediction or the reconstruction of the current video.

In a fifth aspect, a method for storing a bitstream of a video is proposed. The method comprises: determining at least one target intra prediction mode for a current video block of the video based on neighboring reconstructed samples of the current video block; determining a prediction or a reconstruction of the current video block based on a combination of the at least one target intra prediction mode and one of an inter coding tool or a candidate coding tool, the candidate coding tool being used for determining a reference block for the current video block with samples in a current picture associated with the current video block; generating the bitstream based on the prediction or the reconstruction of the current video; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram of an example video coding system in accordance with some embodiments of the present disclosure;

FIG. 2 illustrates a block diagram of an example video encoder in accordance with some embodiments of the present disclosure;

FIG. 3 illustrates a block diagram of an example video decoder in accordance with some embodiments of the present disclosure;

FIG. 4 illustrates an example of encoder block diagram;

FIG. 5 illustrates a schematic diagram of intra prediction modes;

FIG. 6 illustrates a schematic diagram of reference samples for wide-angular intra prediction;

FIG. 7 illustrates a schematic diagram of a problem of discontinuity in case of directions beyond 45°;

FIG. 8 illustrates a schematic diagram of locations of the samples used for the derivation of a and 3;

FIG. 9A illustrates a schematic diagram of a definition of samples used by PDPC applied to a diagonal top-right mode of diagonal and adjacent angular intra modes;

FIG. 9B illustrates a schematic diagram of a definition of samples used by PDPC applied to a diagonal bottom-left mode of diagonal and adjacent angular intra modes;

FIG. 9C illustrates a schematic diagram of a definition of samples used by PDPC applied to an adjacent diagonal top-right mode of diagonal and adjacent angular intra modes;

FIG. 9D illustrates a schematic diagram of a definition of samples used by PDPC applied to an adjacent diagonal bottom-left mode of diagonal and adjacent angular intra modes;

FIG. 10 illustrates a schematic diagram of a gradient approach for non-vertical/non-horizontal mode;

FIG. 11 illustrates a schematic diagram of nScale values with respect to nTbH and mode number;

FIG. 12 illustrates flowcharts of a conventional PDPC and proposed PDPC;

FIG. 13 illustrates a schematic diagram of neighboring blocks used in the derivation of a general MPM list;

FIG. 14 illustrates a schematic diagram of an example on proposed intra reference mapping;

FIG. 15 illustrates a schematic diagram of an example of four reference lines neighboring to a prediction block;

FIG. 16A illustrates a schematic diagram of a process of sub-partition depending on the block size;

FIG. 16B illustrates a schematic diagram of a process of sub-partition depending on the block size;

FIG. 17 illustrates a schematic diagram of a matrix weighted intra prediction process;

FIG. 18 illustrates target samples, template samples and the reference samples of template used in the DIMD;

FIG. 19 illustrates a schematic diagram of a set of chosen pixels on which a gradient analysis is performed;

FIG. 20 illustrates a schematic diagram of a convolution of a 3×3 Sobel gradient filter with the template;

FIG. 21 illustrates a schematic diagram of a proposed intra block decoding process;

FIG. 22 illustrates a schematic diagram of a HoG computation from a template of width 3 pixels;

FIG. 23 illustrates a schematic diagram of a prediction fusion by weighted averaging of two HoG modes and planar;

FIG. 24 illustrates a schematic diagram of top and left neighboring blocks used in CIIP weight derivation;

FIG. 25 illustrates a schematic diagram of examples of the GPM splits grouped by identical angles;

FIG. 26 illustrates a schematic diagram of uni-prediction MV selection for geometric partitioning mode;

FIG. 27 illustrates a schematic diagram of exemplified generation of a bending weight w_0 using geometric partitioning mode;

FIG. 28 illustrates a schematic diagram of conventional angular IPMs and extended angular IPMs;

FIG. 29 illustrates a flowchart of a method for video processing in accordance with some embodiments of the present disclosure; and

FIG. 30 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

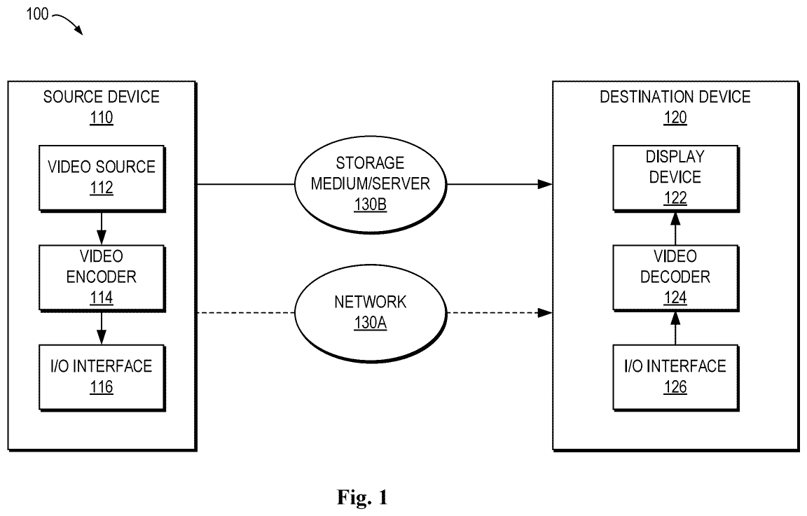

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

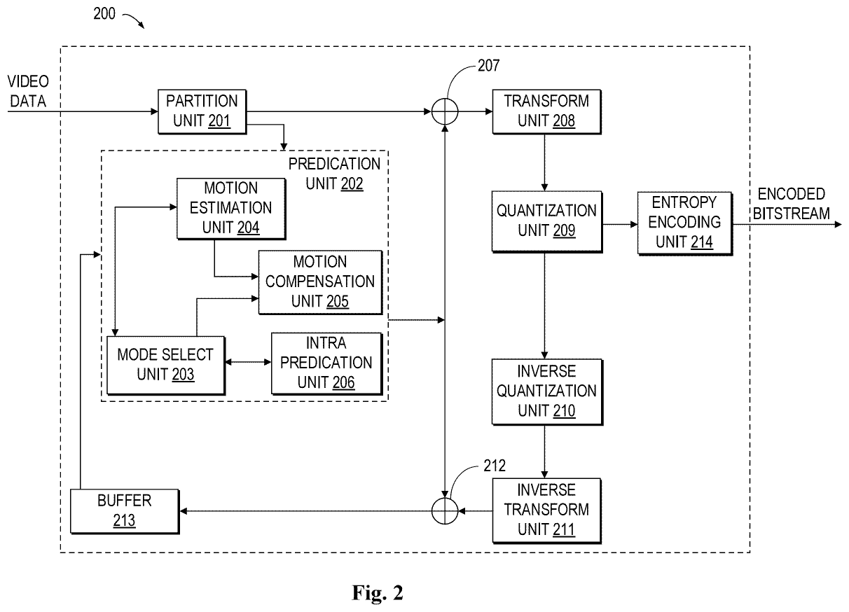

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

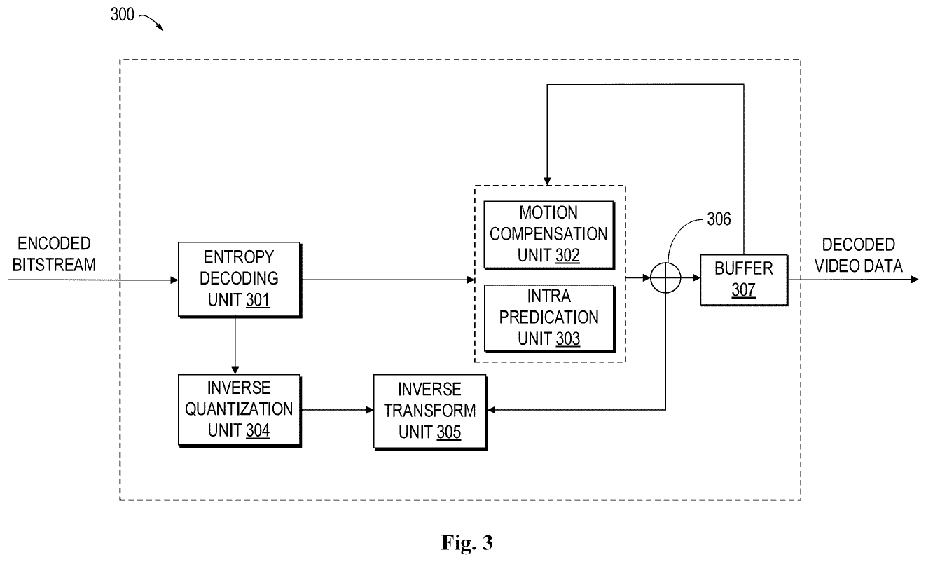

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

This disclosure is related to video coding technologies. Specifically, it is related a coding tool that derives intra prediction mode using previously decoded blocks, and most probable modes (MPM) list construction, and interaction between derived intra prediction modes and inter coding tools, and other coding tools in image/video coding. It may be applied to the existing video coding standard like HEVC, or Versatile Video Coding (VVC). It may be also applicable to future video coding standards or video codec.

### 2. Background

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC. The latest version of VVC draft, i.e., Versatile Video Coding (Draft 10) could be found at: http://phenix.it-sudparis.eu/jvet/doc_end_user/documents/20_Teleconference/wg11/JVET-T2001-v1.zip The latest reference software of VVC, named VTM, could be found at: https://vcgit.hhi.fraunhofer.de/jvet/VVCSoftware_VTM/-/tags/VTM-11.0

### 2.1. Coding Flow of a Typical Video Codec

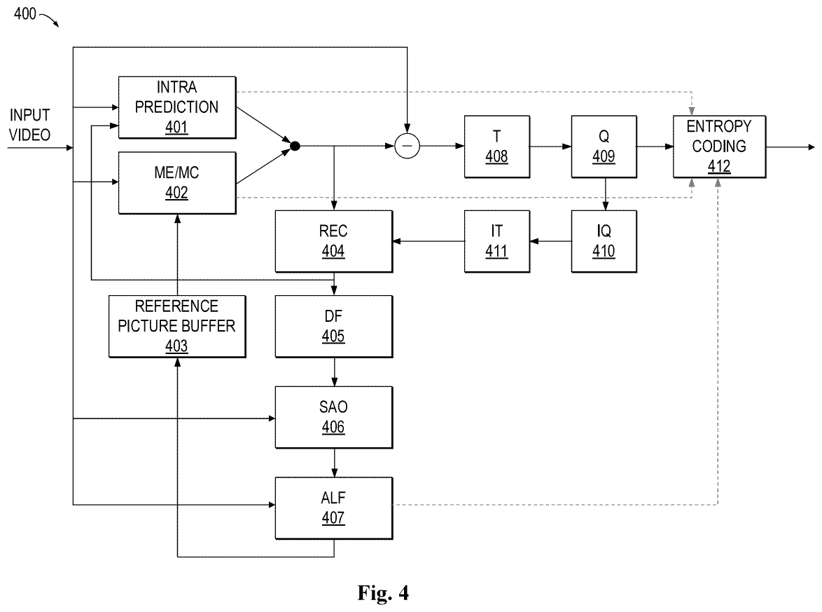

FIG. 4 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

### 2.2. Intra Mode Coding with 67 Intra Prediction Modes

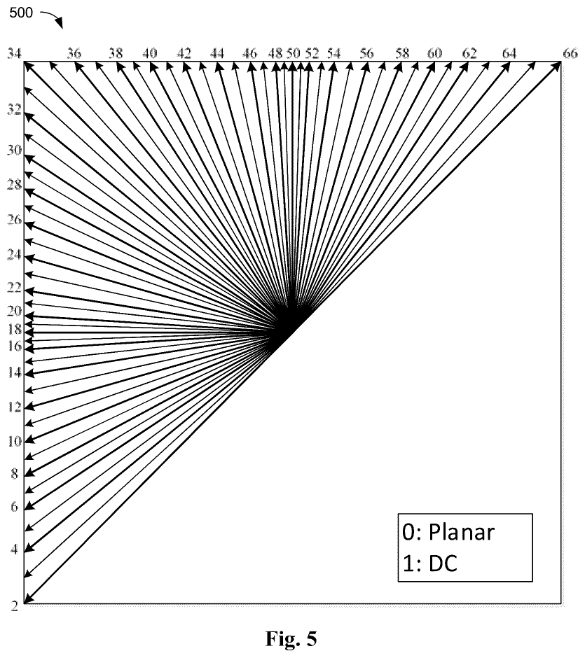

To capture the arbitrary edge directions presented in natural video, the number of directional intra modes is extended from 33, as used in HEVC, to 65, as shown in FIG. 5, and the planar and DC modes remain the same. FIG. 5 illustrates a schematic diagram of intra prediction modes. These denser directional intra prediction modes apply for all block sizes and for both luma and chroma intra predictions.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

Wide Angle Intra Prediction

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

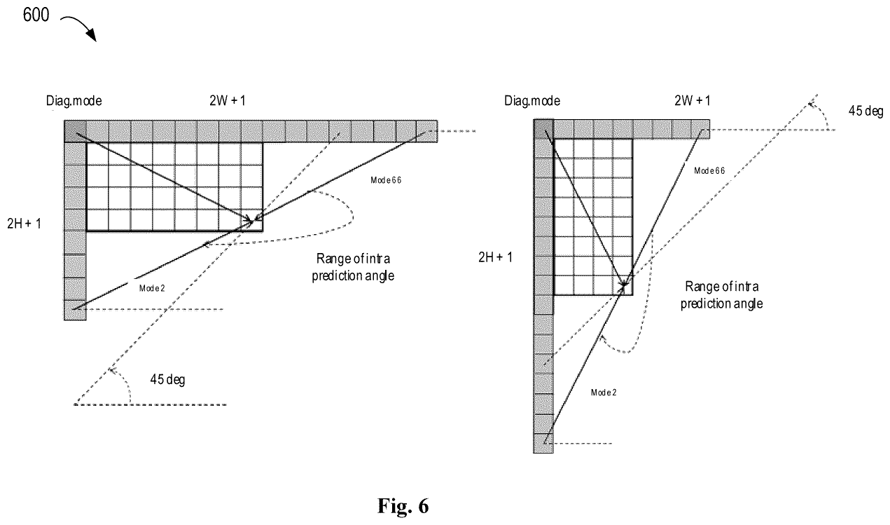

To support these prediction directions, the top reference with length 2W+1, and the left reference with length 2H+1, are defined as shown in FIG. 6. FIG. 6 illustrates a schematic diagram of reference samples for wide-angular intra prediction.

The number of replaced modes in wide-angular direction mode depends on the aspect ratio of a block. The replaced intra prediction modes are illustrated in Table 2-1

TABLE 2-1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, |
| | 65, 66 |

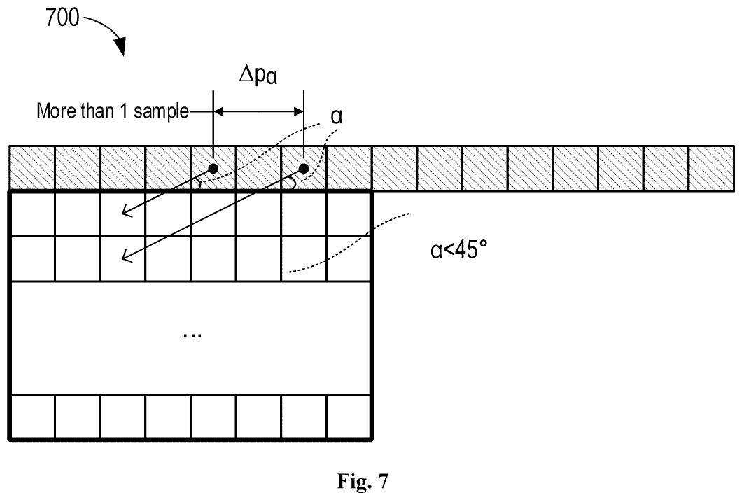

FIG. 7 illustrates a schematic diagram of a problem of discontinuity in case of directions beyond 45°. As shown in FIG. 7, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 2.3. Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 2.4. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### 2.5. Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

pred_{C}(i,j)=α·rec_{L}′(i,j)+β (2-1)

where pred_{C}(i,j) represents the predicted chroma samples in a CU and rec_{L}(i,j) represents the down-sampled reconstructed luma samples of the same CU.

The CCLM parameters (α and β) are derived with at most four neighbouring chroma samples and their corresponding down-sampled luma samples. Suppose the current chroma block dimensions are W×H, then W″ and H′ are set as
W′=W, H′=H when LM mode is applied;
W′=W+H when LM-T mode is applied;
H′=H+W when LM-L mode is applied;

The above neighbouring positions are denoted as S[0, −1] . . . S[W′−1, −1] and the left neighbouring positions are denoted as S[−1, 0] . . . S[−1, H′−1]. Then the four samples are selected as
S[W′/4, −1], S[3*W′/4, −1], S[−1, H′/4], S[−1, 3*H′/4] when LM mode is applied and both above and left neighbouring samples are available;
S[W′/8,−1],S[3*W′/8,−1],S[5*W′/8,−1],S[7*W′/8,−1] when LM-T mode is applied or only the above neighbouring samples are available;
S[−1, H′/8], S[−1, 3*H′/8], S[−1, 5*H′/8], S[−1, 7*H′/8] when LM-L mode is applied or only the left neighbouring samples are available;

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

Xₐ=(x⁰_{A}+x¹_{A}+1)>>1;X_{b}=(x⁰_{B}+x¹_{B}+1)>>1;Yₐ(y⁰_{A}+y¹_{A}+1)>>1;Y_{b}(y⁰_{B}+y¹_{B}+1)>>1 (2-2)

Finally, the linear model parameters α and β are obtained according to the following equations.

$$α = \frac{{Y}_{a} - {Y}_{b}}{{X}_{a} - {X}_{b}} \qquad ( 2 - 3 )$$

$$β = {Y}_{b} - α \cdot {X}_{b} \qquad ( 2 - 4 )$$

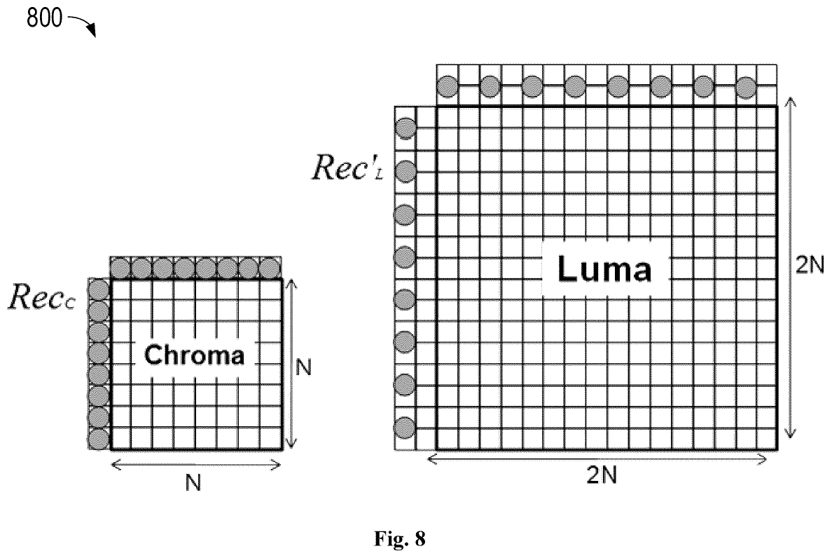

FIG. 8 shows an example of the location of the left and above samples and the sample of the current block involved in the CCLM mode. FIG. 8 illustrates a schematic diagram of locations of the samples used for the derivation of α and β

The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

DivTable[ ]={0,7,6,5,5,4,4,3,3,2,2,1,1,1,1,0} (2-5)

This would have a benefit of both reducing the complexity of the calculation as well as the memory size required for storing the needed tables

Besides the above template and left template can be used to calculate the linear model coefficients together, they also can be used alternatively in the other 2 LM modes, called LM_T, and LM_L modes.

In LM_T mode, only the above template is used to calculate the linear model coefficients. To get more samples, the above template is extended to (W+H) samples. In LM_L mode, only left template is used to calculate the linear model coefficients. To get more samples, the left template is extended to (H+W) samples.

In LM mode, left and above templates are used to calculate the linear model coefficients.

To match the chroma sample locations for 4:2:0 video sequences, two types of down-sampling filter are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$${Rec}_{L}^{′} ( i , j ) = [ \begin{matrix}{rec}_{L} ( 2 i - 1 , 2 j - 1 ) + \\ 2 \cdot {rec}_{L} ( 2 i - 1 , 2 j - 1 ) + \\ {rec}_{L} ( 2 i + 1 , 2 j - 1 ) + \\ {rec}_{L} ( 2 i - 1 , 2 j ) + 2 \cdot {rec}_{L} ( 2 i , 2 j ) + \\ {rec}_{L} ( 2 i + 1 , 2 j ) + 4\end{matrix} ] ≫ 3 \qquad ( 2 - 6 )$$

$${rec}_{L}^{′} ( i , j ) = [ \begin{matrix}{rec}_{L} ( 2 i , 2 j - 1 ) + \\ {rec}_{L} ( 2 i - 1 , 2 j ) + \\ 4 \cdot {rec}_{L} ( 2 i , 2 j ) + \\ {rec}_{L} ( 2 i + 1 , 2 j ) + \\ {rec}_{L} ( 2 i , 2 j + 1 ) + 4\end{matrix} ] ≫ 3 \qquad ( 2 - 7 )$$

Note that only one luma line (general line buffer in intra prediction) is used to make the down-sampled luma samples when the upper reference line is at the CTU boundary.

This parameter computation is performed as part of the decoding process, and is not just as an encoder search operation. As a result, no syntax is used to convey the α and β values to the decoder.

For chroma intra mode coding, a total of 8 intra modes are allowed for chroma intra mode coding. Those modes include five traditional intra modes and three cross-component linear model modes (LM, LM_T, and LM_L). Chroma mode signalling and derivation process are shown in Table 2-2. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 2-2
Derivation of chroma prediction mode
from luma mode when CCLM is enabled

| Chroma | | | | | |
|---|---|---|---|---|---|
| prediction | Corresponding luma intra prediction mode | | | | |
| mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 2-3.

TABLE 2-3
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 2-3, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_T (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded.

This single binarization table is used for both sps_cclm_enabled_flag equal to 0 and 1 cases. The first two bins in Table 2-3 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node is allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### 2.6. Position Dependent Intra Prediction Combination

In VVC, the results of intra prediction of DC, planar and several angular modes are further modified by a position dependent intra prediction combination (PDPC) method. PDPC is an intra prediction method which invokes a combination of the boundary reference samples and HEVC style intra prediction with filtered boundary reference samples. PDPC is applied to the following intra modes without signalling: planar, DC, intra angles less than or equal to horizontal, and intra angles greater than or equal to vertical and less than or equal to 80. If the current block is BDPCM mode or MRL index is larger than 0, PDPC is not applied.

The prediction sample pred(x′,y′) is predicted using an intra prediction mode (DC, planar, angular) and a linear combination of reference samples according to the Equation 2-8 as follows:

pred(x′,y′)=Clip(0,(1<<BitDepth)−1,(wL×R_{-1,y′}+wT×R_{x′,1}+(64−wL−wT)×pred(x′,y′)+32)>>6) (2-8)

where R_{x,-1}, R_{-1,y} represent the reference samples located at the top and left boundaries of current sample (x, y), respectively.

If PDPC is applied to DC, planar, horizontal, and vertical intra modes, additional boundary filters are not needed, as required in the case of HEVC DC mode boundary filter or horizontal/vertical mode edge filters. PDPC process for DC and Planar modes is identical. For angular modes, if the current angular mode is HOR_IDX or VER_IDX, left or top reference samples is not used, respectively. The PDPC weights and scale factors are dependent on prediction modes and the block sizes. PDPC is applied to the block with both width and height greater than or equal to 4.

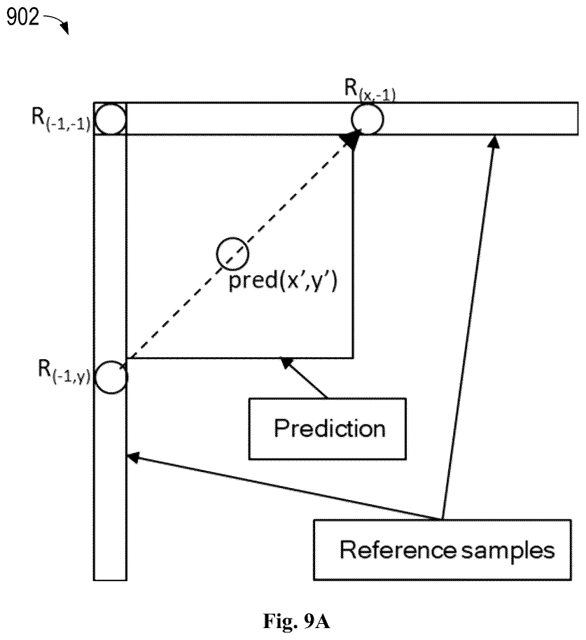

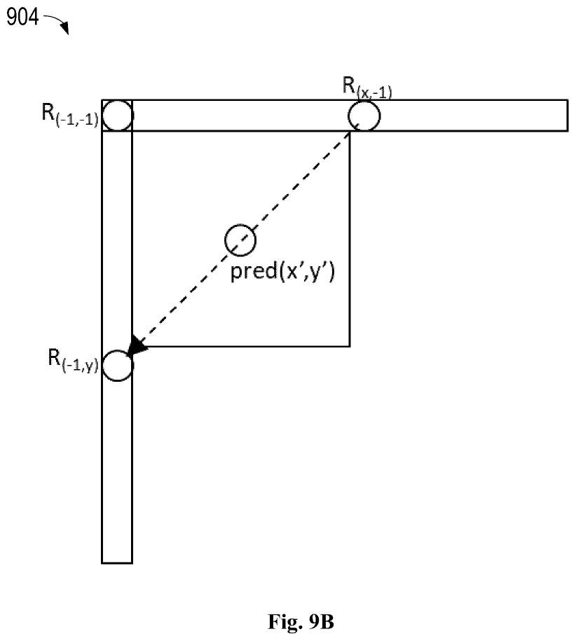

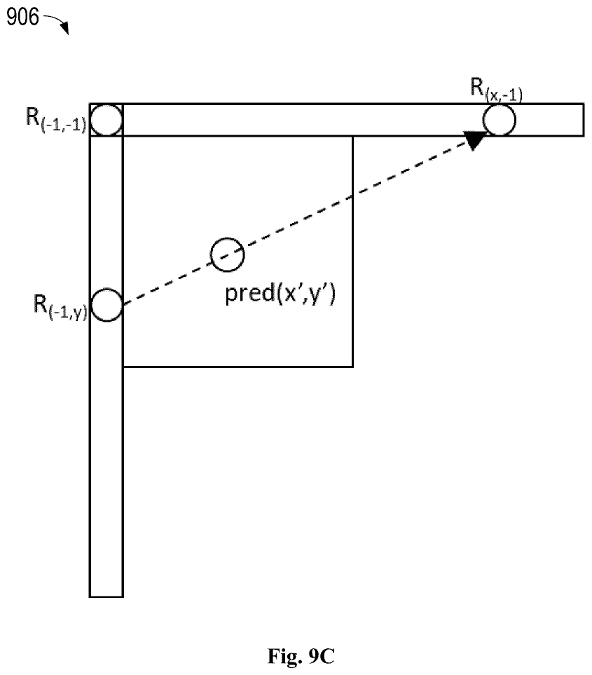

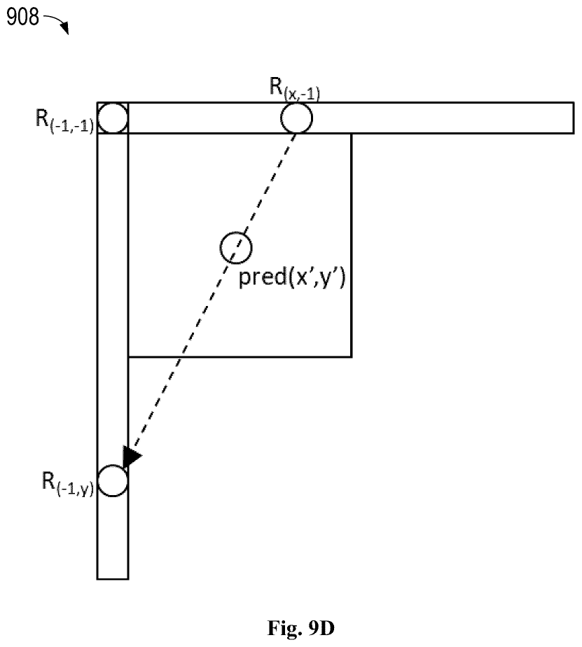

FIGS. 9A-9D illustrate the definition of reference samples (R_{x,-1} and R_{-1,y}) for PDPC applied over various prediction modes. FIG. 9A illustrates a schematic diagram of a definition of samples used by PDPC applied to a diagonal top-right mode of diagonal and adjacent angular intra modes. FIG. 9B illustrates a schematic diagram of a definition of samples used by PDPC applied to a diagonal bottom-left mode of diagonal and adjacent angular intra modes. FIG. 9C illustrates a schematic diagram of a definition of samples used by PDPC applied to an adjacent diagonal top-right mode of diagonal and adjacent angular intra modes. FIG. 9D illustrates a schematic diagram of a definition of samples used by PDPC applied to an adjacent diagonal bottom-left mode of diagonal and adjacent angular intra modes. The prediction sample pred(x′, y′) is located at (x′, y′) within the prediction block. As an example, the coordinate x of the reference sample R_{x,-1} is given by: x=x′+y′+1, and the coordinate y of the reference sample R_{-1,y} is similarly given by: y=x′+y′+1 for the diagonal modes. For the other angular mode, the reference samples R_{x,-1} and R_{-1,y} could be located in fractional sample position. In this case, the sample value of the nearest integer sample location is used.

### 2.7. Gradient PDPC

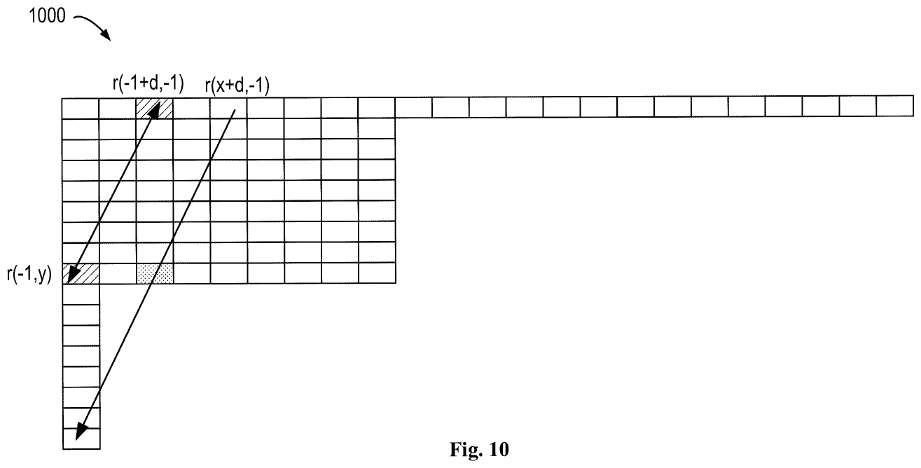

The gradient based approach is extended for non-vertical/non-horizontal mode, as shown in FIG. 10. FIG. 10 illustrates a schematic diagram of a gradient approach for non-vertical/non-horizontal mode. Here, the gradient is computed as r(−1, y)−r(−1+d, −1), where d is the horizontal displacement depending on the angular direction. A few points to note here:

The gradient term r(−1, y)−r(−1+d, −1) is needed to be computed once for every row, as it does not depend on the x position.

The computation of d is already part of original intra prediction process which can be reused, so a separate computation of d is not needed. Accordingly, d is in 1/32 pixel accuracy

Two tap (linear) filtering are used when d is at fractional position, i.e., if dPos is the displacement in 1/32 pixel accuracy, dInt is the (floored) integer part (dPos>>5), and dFract is the fractional part in 1/32 pixel accuracy (dPos & 31), then r(−1+d) is computed as:

r(−1+d)=(32−dFrac)*r(−1+dInt)+dFrac*r(−1+dInt+1)

This 2 tap filtering is performed once per row (if needed), as explained in a.

Finally, the prediction signal is computed

p(x,y)=Clip(((64−wL(x))*p(x,y)+wL(x)*(r(−1,y)−r(−1+d,−1))+32)>>6)

Where wL(x)=32>>((x<<1)>>nScale2), and nScale2=(log 2(nTbH)+log 2(nTbW)−2)>>2, which are the same as vertical/horizontal mode. In a nutshell, the same process is applied compared to vertical/horizontal mode (in fact, d=0 indicates vertical/horizontal mode).

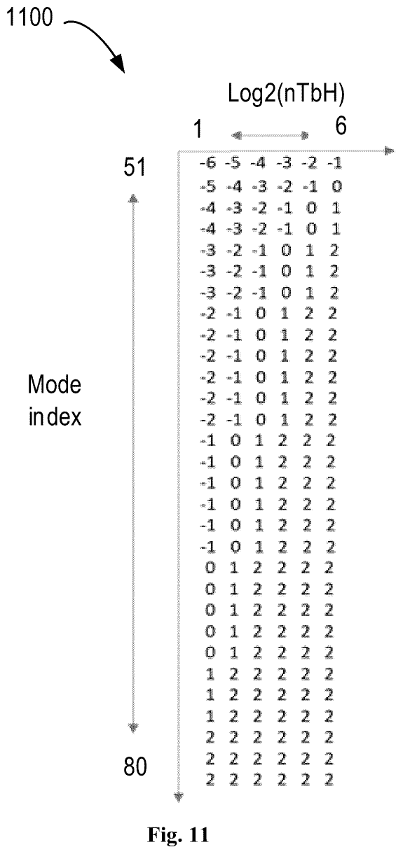

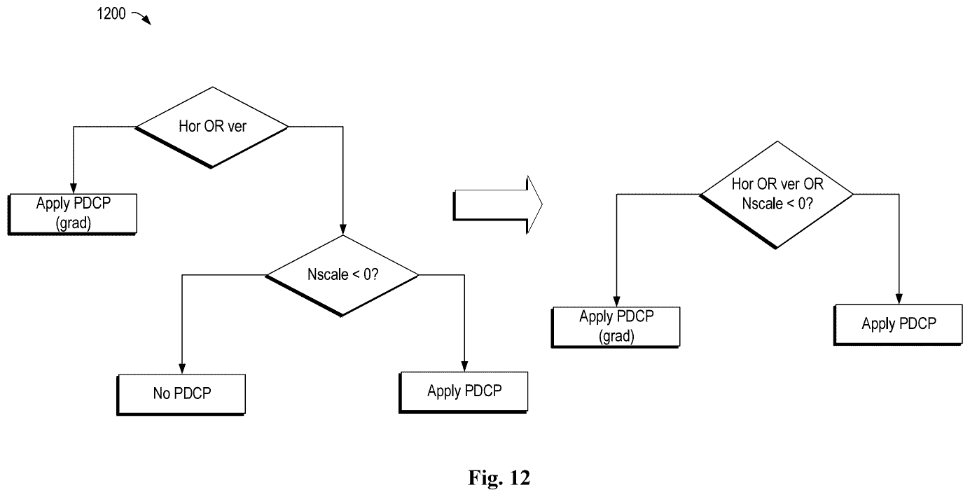

Second, the gradient based approach is activated for non-vertical/non-horizontal mode when (nScale<0) or when PDPC can't be applied due to unavailability of secondary reference sample. The values of nScale are shown in FIG. 11, with respect to TB size and angular mode, to better visualize the cases where gradient approach is used. FIG. 11 illustrates a schematic diagram of nScale values with respect to nTbH and mode number; for all nScale<0 cases gradient approach is used. Additionally, in FIG. 12, the flowchart for conventional PDPC (left) and proposed PDPC (right) is shown.

### 2.8. Secondary MPM

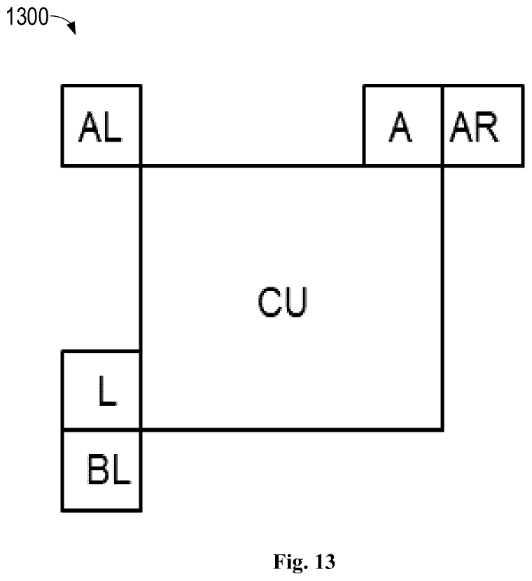

Secondary MPM lists is introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in FIG. 13, the directional modes with added offset from the first two available directional modes of neighbouring blocks, and the default modes. FIG. 13 illustrates a schematic diagram of neighboring blocks (L, A, BL, AR, AL) used in the derivation of a general MPM list

If a CU block is vertically oriented, the order of neighbouring blocks is A, L, BL, AR, AL; otherwise, it is L, A, BL, AR, AL.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### 2.9. 6-Tap Intra Interpolation Filter

To improve prediction accuracy, it is proposed to replace 4-tap Cubic interpolation filter with 6-tap interpolation filter, the filter coefficients are derived based on the same polynomial regression model, but with polynomial order of 6.

Filter coefficients are listed below,
{0, 0, 256, 0, 0, 0}, // 0/32 position
{0, −4,253, 9, −2, 0}, // 1/32 position
{1, −7, 249, 17, −4, 0}, // 2/32 position
{1, −10, 245, 25, −6, 1}, // 3/32 position
{1, −13, 241, 34, −8, 1}, // 4/32 position
{2, −16, 235, 44, −10, 1}, // 5/32 position
{2, −18, 229, 53, −12, 2}, // 6/32 position
{2, −20, 223, 63, −14, 2}, // 7/32 position
{2, −22, 217, 72, −15, 2}, // 8/32 position
{3, −23, 209, 82, −17, 2}, // 9/32 position
{3, −24, 202, 92, −19, 2}, // 10/32 position
{3, −25, 194, 101, −20, 3}, // 11/32 position
{3, −25, 185, 111, −21, 3}// 12/32 position
{3, −26, 178, 121, −23, 3}// 13/32 position
{3, −25, 168, 131, −24, 3}// 14/32 position
{3, −25, 159, 141, −25, 3}// 15/32 position
{3, −25, 150, 150, −25, 3}// half-pel position

The reference samples used for interpolation come from reconstructed samples or padded as in HEVC, so that the conditional check on reference sample availability is not needed.

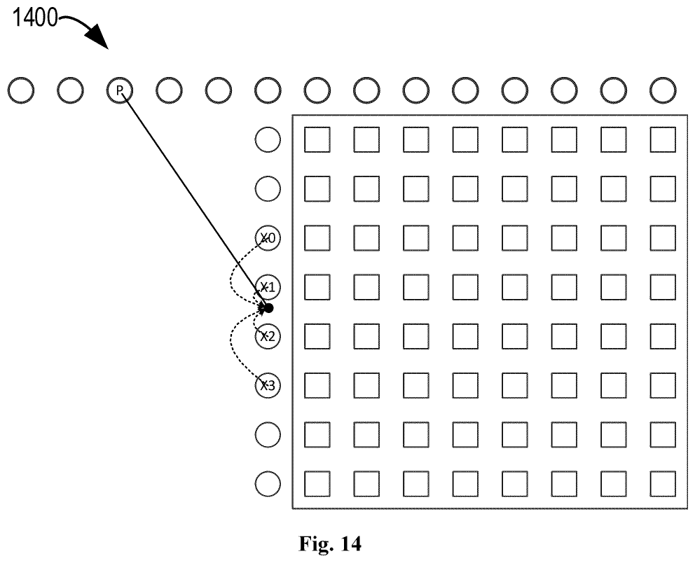

Instead of using nearest rounding operation to derive the extended Intra reference sample, it is proposed to use 4-tap Cubic interpolation filter. FIG. 14 illustrates a schematic diagram of an example on proposed intra reference mapping. As shown in an example in FIG. 14, to derive the value of reference sample P, a four tap interpolation filter is used, while in JEM-3.0 or HM, P is directly set as XL.

### 2.10. Multiple Reference Line (MRL) Intra Prediction

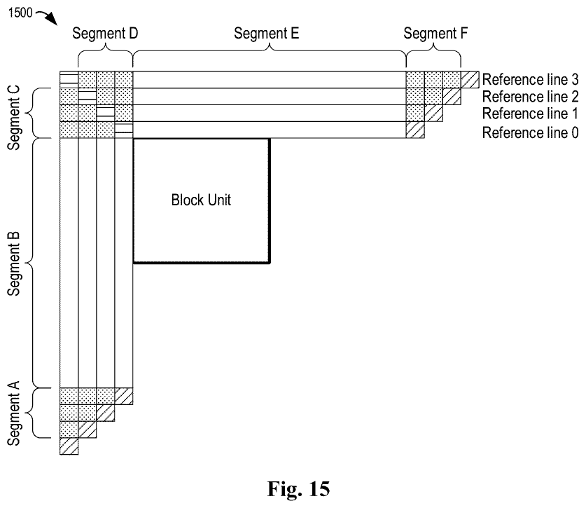

Multiple reference line (MRL) intra prediction uses more reference lines for intra prediction. FIG. 15 illustrates a schematic diagram of an example of four reference lines neighboring to a prediction block. In FIG. 15, an example of 4 reference lines is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 3) are used. The index of selected reference line (mrl_idx) is signalled and used to generate intra predictor. For reference line index, which is greater than 0, only include additional reference line modes in MPM list and only signal MPM index without remaining mode. The reference line index is signalled before intra prediction modes, and Planar mode is excluded from intra prediction modes in case a nonzero reference line index is signalled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices are aligned with that of reference line index 0. MRL requires the storage of 3 neighbouring luma reference lines with a CTU to generate predictions. The Cross-Component Linear Model (CCLM) tool also requires 3 neighbouring luma reference lines for its down-sampling filters. The definition of MRL to use the same 3 lines is aligned as CCLM to reduce the storage requirements for decoders.

### 2.11. Intra Sub-Partitions (ISP)

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB and two corresponding

$$\frac{M}{2} \times 64$$

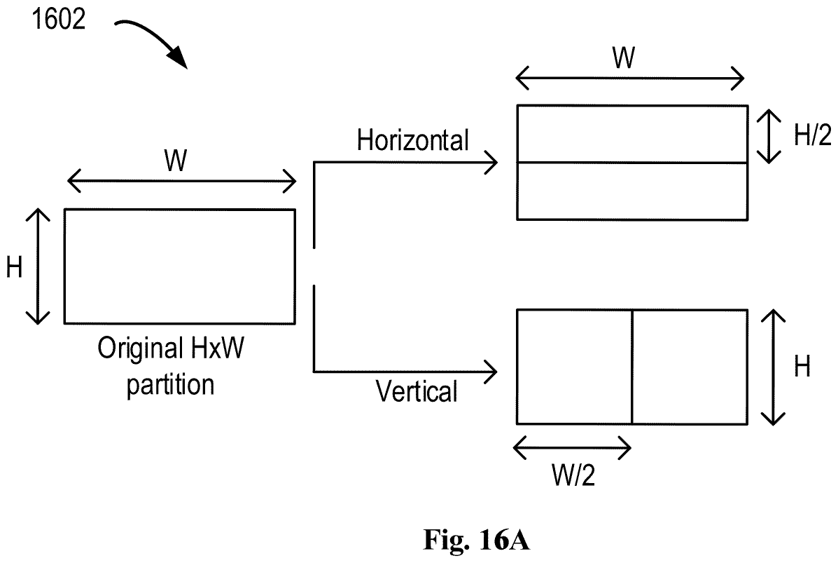

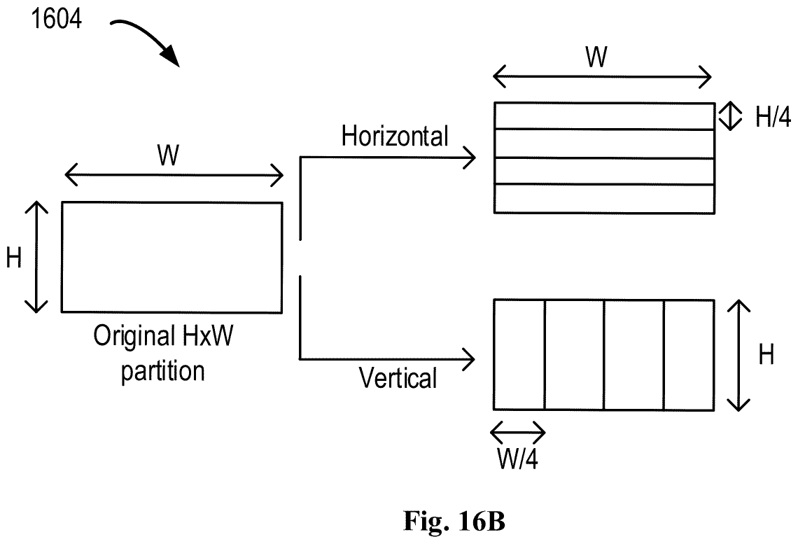

chroma TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU sizes that can use ISP is restricted to a maximum of 64×64. FIGS. 16A and 16B show examples of the two possibilities. FIG. 16A illustrates a schematic diagram 1602 of a process of sub-partition for 4×8 and 8×4 CUs. FIG. 16B illustrates a schematic diagram 1604 of a process of sub-partition for CUs other than 4×8, 8×4 and 4×4. All sub-partitions fulfill the condition of having at least 16 samples.

In ISP, the dependence of 1×N/2×N subblock prediction on the reconstructed values of previously decoded 1×N/2×N subblocks of the coding block is not allowed so that the minimum width of prediction for subblocks becomes four samples. For example, an 8×N (N>4) coding block that is coded using ISP with vertical split is split into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks than processing 4×4 regular-coded intra blocks.

TABLE 2-4
Entropy coding coefficient group size

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 2-4. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n−1 sub-partitions have produced a zero CBF, then the CBF of the n-th sub-partition is inferred to be 1.
Transform size restriction: all ISP transforms with a length larger than 16 points uses the DCT-II.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let t_{H} and t_{V} be the horizontal and the vertical transforms selected respectively for the w×h sub-partition, where w is the width and h is the height. Then the transform is selected according to the following rules:
   If w=1 or h=1, then there is no horizontal or vertical transform respectively.
   If w≥4 and w≤16, t_{H}=DST-VII, otherwise, t_{H}=DCT-II
   If h≥4 and h≤16, t_{V}=DST-VII, otherwise, t_{V}=DCT-II

In ISP mode, all 67 intra prediction modes are allowed. PDPC is also applied if corresponding width and height is at least 4 samples long. In addition, the reference sample filtering process (reference smoothing) and the condition for intra interpolation filter selection doesn't exist anymore, and Cubic (DCT-IF) filter is always applied for fractional position interpolation in ISP mode.

### 2.12. Matrix Weighted Intra Prediction (MIP)

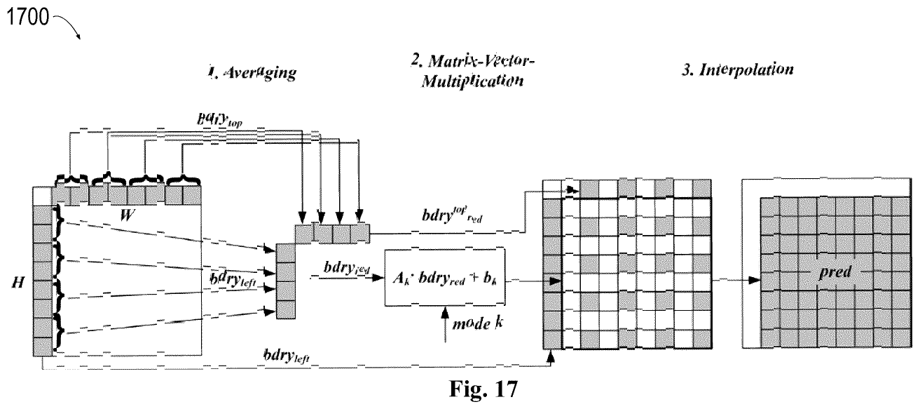

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 17. FIG. 17 illustrates a schematic diagram of a matrix weighted intra prediction process.

Averaging Neighbouring Samples

Among the boundary samples, four samples or eight samples are selected by averaging based on block size and shape. Specifically, the input boundaries bdry^{top} and bdry^{left} are reduced to smaller boundaries bdry_{red}^{top} and bdry_{red}^{left} by averaging neighbouring boundary samples according to predefined rule depends on block size. Then, the two reduced boundaries bdry_{red}^{top} and bdry_{red}^{left} are concatenated to a reduced boundary vector bdry_{red} which is thus of size four for blocks of shape 4×4 and of size eight for blocks of all other shapes. If mode refers to the MIP-mode, this concatenation is defined as follows:

$$b d r {y}_{red} = \{ \begin{matrix}[ b d r {y}_{red}^{top} , b d r {y}_{red}^{left} ] & for W = H = 4 and mode < 18 \\ [ b d r {y}_{red}^{left} , b d r {y}_{red}^{top} ] & for W = H = 4 and mode \geq 18 \\ [ b d r {y}_{red}^{top} , b d r {y}_{red}^{left} ] & for max ( W , H ) = 8 and mode < 10 \\ [ b d r {y}_{red}^{left} , b d r {y}_{red}^{top} ] & for max ( W , H ) = 8 and mode \geq 10 \\ [ b d r {y}_{red}^{top} , b d r {y}_{red}^{left} ] & for max ( W , H ) > 8 and mode < 6 \\ [ b d r {y}_{red}^{left} , b d r {y}_{red}^{top} ] & for max ( W , H ) > 8 and mode \geq 6.\end{matrix} \qquad ( 2 - 9 )$$

Matrix Multiplication

A matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the down-sampled block of width W_{red} and height H_{red} is generated. Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix} \qquad ( 2 - 10 )$$

$${H}_{red} = \{ \begin{matrix}4 & for max ( W , H ) \leq 8 \\ min ( H , 8 ) & for max ( W , H ) > 8\end{matrix} \qquad ( 2 - 11 )$$

The reduced prediction signal pred_{red} is computed by calculating a matrix vector product and adding an offset:

pred_{red}=A·bdry_{red}+b. (2-12)

Here, A is a matrix that has W_{red}·H_{red} rows and 4 columns if W=H=4 and 8 columns in all other cases. b is a vector of size W_{red}·H_{red}. The matrix A and the offset vector b are taken from one of the sets S₀, S₁, S₂. One defines an index idx=idx(W, H) as follows:

$$idx ( W , H ) = \{ \begin{matrix}0 & for W = H = 4 \\ 1 & for max ( W , H ) = 8 \\ 2 & for max ( W , H ) > 8.\end{matrix} \qquad ( 2 - 13 )$$

Here, each coefficient of the matrix A is represented with 8 bit precision. The set S₀ consists of 16 matrices A₀ⁱ, iϵ{0, . . . , 15} each of which has 16 rows and 4 columns and 16 offset vectors b₀ⁱ, iϵ{0, . . . , 16} each of size 16. Matrices and offset vectors of that set are used for blocks of size 4×4. The set S₁ consists of 8 matrices A₁ⁱ, iϵ{0, . . . , 7}, each of which has 16 rows and 8 columns and 8 offset vectors b₁ⁱ, iϵ{0, . . . , 7} each of size 16. The set S₂ consists of 6 matrices A₂ⁱ, iϵ{0, . . . , 5}, each of which has 64 rows and 8 columns and of 6 offset vectors b₂ⁱ, iϵ{0, . . . , 5} of size 64.

Interpolation

The prediction signal at the remaining positions is generated from the prediction signal on the subsampled set by linear interpolation which is a single step linear interpolation in each direction. The interpolation is performed firstly in the horizontal direction and then in the vertical direction regardless of block shape or block size.

Signalling of MIP Mode and Harmonization with Other Coding Tools

For each Coding Unit (CU) in intra mode, a flag indicating whether an MIP mode is to be applied or not is sent. If an MIP mode is to be applied, MIP mode (predModeIntra) is signalled. For an MIP mode, a transposed flag (isTransposed), which determines whether the mode is transposed, and MIP mode Id (modeId), which determines which matrix is to be used for the given MIP mode is derived as follows

isTransposed=predModeIntra&1

modeId=predModeIntra>>1 (2-14)

MIP coding mode is harmonized with other coding tools by considering following aspects:
LFNST is enabled for MIP on large blocks. Here, the LFNST transforms of planar mode are used
The reference sample derivation for MIP is performed exactly as for the conventional intra prediction modes
For the up-sampling step used in the MIP-prediction, original reference samples are used instead of down-sampled ones
Clipping is performed before up-sampling and not after up-sampling
MIP is allowed up to 64×64 regardless of the maximum transform size

The number of MIP modes is 32 for sizeId=0, 16 for sizeId=1 and 12 for sizeId=2

### 2.13. Decoder-Side Intra Mode Derivation

In JEM-2.0 intra modes are extended to 67 from 35 modes in HEVC, and they are derived at encoder and explicitly signalled to decoder. A significant amount of overhead is spent on intra mode coding in JEM-2.0. For example, the intra mode signalling overhead may be up to 5-10% of overall bitrate in all intra coding configuration. This contribution proposes the decoder-side intra mode derivation approach to reduce the intra mode coding overhead while keeping prediction accuracy.

To reduce the overhead of intra mode signalling, this contribution presents a decoder-side intra mode derivation (DIMD) approach. In the proposed approach, instead of signalling intra mode explicitly, the information is derived at both encoder and decoder from the neighbouring reconstructed samples of current block. The intra mode derived by DIMD is used in two ways:
1) For 2N×2N CUs, the DIMD mode is used as the intra mode for intra prediction when the corresponding CU-level DIMD flag is turned on;
2) For N×N CUs, the DIMD mode is used to replace one candidate of the existing MPM list to improve the efficiency of intra mode coding.

Templated Based Intra Mode Derivation

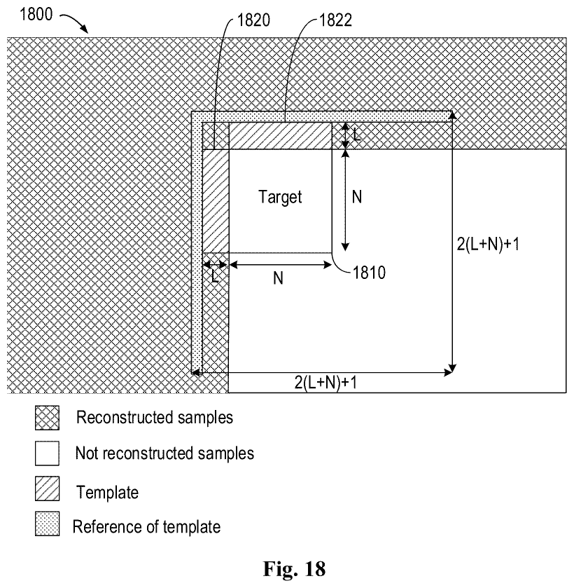

FIG. 18 illustrates target samples, template samples and the reference samples of template used in the DIMD. As illustrated in FIG. 18, the target denotes the current block (of block size N) for which intra prediction mode is to be estimated. The template (indicated by the patterned region in FIG. 18) specifies a set of already reconstructed samples, which are used to derive the intra mode. The template size is denoted as the number of samples within the template that extends to the above and the left of the target block, i.e., L. In the current implementation, a template size of 2 (i.e., L=2) is used for 4×4 and 8×8 blocks and a template size of 4 (i.e., L=4) is used for 16×16 and larger blocks. The reference of template (indicated by the dotted region in FIG. 18) refers to a set of neighbouring samples from above and left of the template, as defined by JEM-2.0. Unlike the template samples which are always from reconstructed region, the reference samples of template may not be reconstructed yet when encoding/decoding the target block. In this case, the existing reference samples substitution algorithm of JEM-2.0 is utilized to substitute the unavailable reference samples with the available reference samples.

For each intra prediction mode, the DIMD calculates the absolute difference (SAD) between the reconstructed template samples and its prediction samples obtained from the reference samples of the template. The intra prediction mode that yields the minimum SAD is selected as the final intra prediction mode of the target block.

DIMD for Intra 2N×2N CUs

For intra 2N×2N CUs, the DIMD is used as one additional intra mode, which is adaptively selected by comparing the DIMD intra mode with the optimal normal intra mode (i.e., being explicitly signalled). One flag is signalled for each intra 2N×2N CU to indicate the usage of the DIMD. If the flag is one, then the CU is predicted using the intra mode derived by DIMD; otherwise, the DIMD is not applied and the CU is predicted using the intra mode explicitly signalled in the bit-stream. When the DIMD is enabled, chroma components always reuse the same intra mode as that derived for luma component, i.e., DM mode.

Additionally, for each DIMD-coded CU, the blocks in the CU can adaptively select to derive their intra modes at either PU-level or TU-level. Specifically, when the DIMD flag is one, another CU-level DIMD control flag is signalled to indicate the level at which the DIMD is performed. If this flag is zero, it means that the DIMD is performed at the PU level and all the TUs in the PU use the same derived intra mode for their intra prediction; otherwise (i.e., the DIMD control flag is one), it means that the DIMD is performed at the TU level and each TU in the PU derives its own intra mode. Further, when the DIMD is enabled, the number of angular directions increases to 129, and the DC and planar modes still remain the same. To accommodate the increased granularity of angular intra modes, the precision of intra interpolation filtering for DIMD-coded CUs increases from 1/32-pel to 1/64-pel. Additionally, in order to use the derived intra mode of a DIMD coded CU as MPM candidate for neighbouring intra blocks, those 129 directions of the DIMD-coded CUs are converted to “normal” intra modes (i.e., 65 angular intra directions) before they are used as MPM.

DIMD for Intra N×N CUs

In the proposed method, intra modes of intra N×N CUs are always signalled. However, to improve the efficiency of intra mode coding, the intra modes derived from DIMD are used as MPM candidates for predicting the intra modes of four PUs in the CU. In order to not increase the overhead of MPM index signalling, the DIMD candidate is always placed at the first place in the MPM list and the last existing MPM candidate is removed. Also, pruning operation is performed such that the DIMD candidate will not be added to the MPM list if it is redundant.

Intra Mode Search Algorithm of DIMD

In order to reduce encoding/decoding complexity, one straightforward fast intra mode search algorithm is used for DIMD. Firstly, one initial estimation process is performed to provide a good starting point for intra mode search. Specifically, an initial candidate list is created by selecting N fixed modes from the allowed intra modes. Then, the SAD is calculated for all the candidate intra modes and the one that minimizes the SAD is selected as the starting intra mode. To achieve a good complexity/performance trade-off, the initial candidate list consists of 11 intra modes, including DC, planar and every 4-th mode of the 33 angular intra directions as defined in HEVC, i.e., intra modes 0, 1, 2, 6, 10 . . . 30, 34.

If the starting intra mode is either DC or planar, it is used as the DIMD mode. Otherwise, based on the starting intra mode, one refinement process is then applied where the optimal intra mode is identified through one iterative search. It works by comparing at each iteration the SAD values for three intra modes separated by a given search interval and maintain the intra mode that minimize the SAD. The search interval is then reduced to half, and the selected intra mode from the last iteration will serve as the center intra mode for the current iteration. For the current DIMD implementation with 129 angular intra directions, up to 4 iterations are used in the refinement process to find the optimal DIMD intra mode.

### 2.14. Decoder-Side Intra Mode Derivation

In this contribution, a method is proposed to avoid transmitting the luma intra prediction mode in the bitstream. This is done by deriving the luma intra mode using previously encoded/decoded pixels, in an identical fashion at the encoder and at the decoder. This process defines a new coding mode called DIMD, whose selection is signalled in the bitstream for intra coded blocks using a simple flag. DIMD competes with other coding modes at the encoder, including the classical Intra coding mode (where the intra prediction mode is coded). Note that in this contribution, DIMD only applies to luma. For chroma, classical intra coding mode applies. As done for other coding modes (classical intra, inter, merge, etc.), a rate-distortion cost is computed for the DIMD mode, and is then compared to the coding costs of other modes to decide whether to select it as final coding mode for a current block.

At the decoder side, the DIMD flag is first parsed. If it is true, the intra prediction mode is derived in the reconstruction process using the same previously encoded neighbouring pixels. If not, the intra prediction mode is parsed from the bitstream as in classical intra coding mode.

Intra Prediction Mode Derivation

### 2.14..1. Gradient Analysis

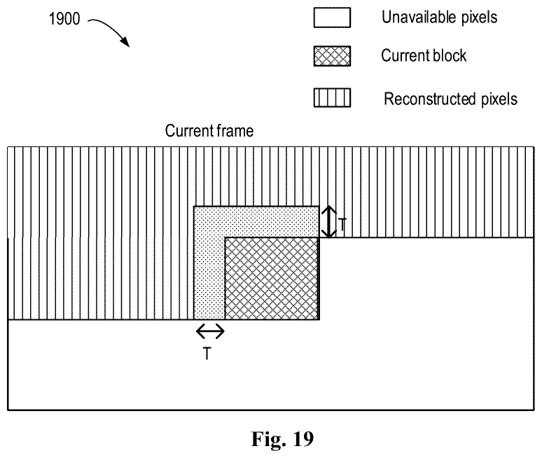

To derive the intra prediction mode for a block, a set of neighbouring pixels are first selected on which a gradient analysis is performed. For normativity purposes, these pixels should be in the decoded/reconstructed pool of pixels. FIG. 19 illustrates a schematic diagram of a set of chosen pixels on which a gradient analysis is performed. As shown in FIG. 19, a template surrounding the current block is chosen by T pixels to the left, and T pixels above. T=2 is set in the proposal.

Next, a gradient analysis is performed on the pixels of the template. This allows to determine a main angular direction for the template, which it is assumed (and that is the core premise of our method) has a high chance to be identical to the one of the current block. Thus, a simple 3×3 Sobel gradient filter is used, defined by the following matrices that will be convoluted with the template:

$${M}_{x} = [ \begin{matrix}- 1 & 0 & 1 \\ - 2 & 0 & 2 \\ - 1 & 0 & 1\end{matrix} ] and {M}_{y} = [ \begin{matrix}- 1 & - 2 & - 1 \\ 0 & 0 & 0 \\ 1 & 2 & 1\end{matrix} ] \qquad ( 2 - 15 )$$

For each pixel of the template, each of these two matrices with the 3×3 window centered around the current pixel is point-by-point multiplied and composed of its 8 direct neighbors, and the result is summed. Thus, two values Gₓ (from the multiplication with Mₓ), and G_{y} (from the multiplication with My) corresponding to the gradient at the current pixel are obtained, in the horizontal and vertical direction respectively.

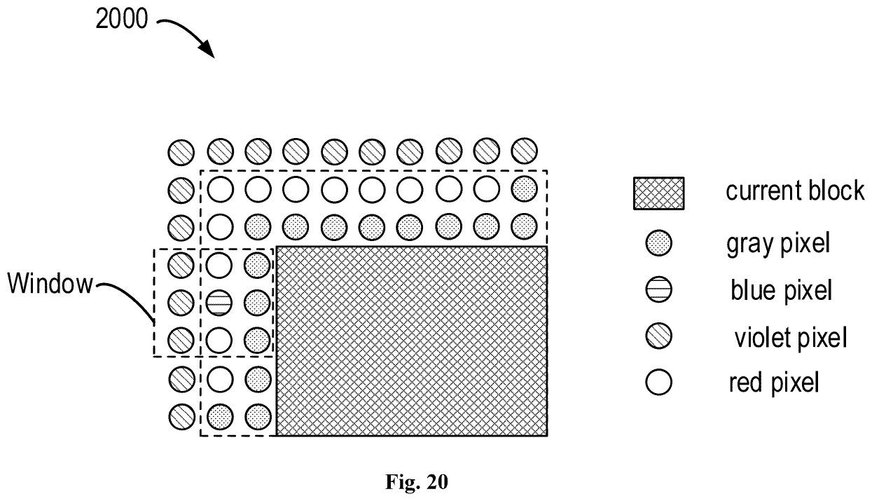

FIG. 20 shows the convolution process. More specifically, FIG. 20 illustrates a schematic diagram of a convolution of a 3×3 Sobel gradient filter with the template. The blue pixel is the current pixel. Red pixels (including the blue) are pixels on which the gradient analysis is possible. Gray pixels are pixels on which the gradient analysis is not possible due to lack of some neighbors. Violet pixels are available (reconstructed) pixels outside of the considered template, used in the gradient analysis of the red pixels. In case a violet pixel is not available (due to blocks being too close to the border of the picture for instance), the gradient analysis of all red pixels that use this violet pixel is not performed.

### 2.14..2. Histogram of Gradients and Mode Derivation

For each red pixel, the intensity (G) and the orientation (O) of the gradient using Gₓ and G_{y} are calculated as such:

$$G = \vert {G}_{x} \vert + \vert {G}_{y} \vert and 0 = atan ( \frac{{G}_{y}}{{G}_{x}} ) \qquad ( 2 - 16 )$$

Note that a fast implementation of the a tan function is proposed. The orientation of the gradient is then converted into an intra angular prediction mode, used to index a histogram (first initialized to zero). The histogram value at that intra angular mode is increased by G. Once all the red pixels in the template have been processed, the histogram will contain cumulative values of gradient intensities, for each intra angular mode. The mode that shows the highest peak in the histogram is selected as intra prediction mode for the current block. If the maximum value in the histogram is 0 (meaning no gradient analysis was able to be made, or the area composing the template is flat), then the DC mode is selected as intra prediction mode for the current block.

For blocks that are located at the top of CTUs, the gradient analysis of the pixels located in the top part of the template is not performed. The DIMD flag is coded using three possible contexts, depending on the left and above neighbouring blocks, similarly to the Skip flag coding. Context 0 corresponds to the case where none of the left and above neighbouring blocks are coded with DIMD mode, context 1 corresponds to the case where only one neighbouring block is coded with DIMD, and context 2 corresponds to the case where both neighbors are DIMD-coded. Initial symbol probabilities for each context are set to 0.5.

Prediction with 130 Intra Modes

One advantage that DIMD offers over classical intra mode coding is that the derived intra mode can have a higher precision, allowing more precise predictions at no additional cost since it is not transmitted in the bitstream. The derived intra mode spans 129 angular modes, hence a total of 130 modes including DC (the derived intra mode can never be planar in our contribution). The classical intra coding mode is unchanged, i.e., the prediction and mode coding still use 67 modes. The required changes to Wide Angle Intra Prediction and simplified PDPC were performed to accommodate for prediction using 129 modes. Note that only the prediction process uses the extended intra modes, meaning that for any other purpose (deciding whether to filter the reference samples for instance), the mode is converted back to 67-mode precision.

Other Normative Changes

In the DIMD mode, the luma intra mode is derived during the reconstruction process, just prior to the block reconstruction. This is done to avoid a dependency on reconstructed pixels during parsing. However, by doing so, the luma intra mode of the block will be undefined for the chroma component of the block, and for the luma component of neighbouring blocks. This causes an issue because:
For chroma, a fixed mode candidate list is defined. Usually, if the luma mode equals one of the chroma candidates, that candidate will be replaced with the vertical diagonal (VDIA_IDX) intra mode. Since in DIMD, the luma mode is unavailable, the initial chroma mode candidate list is not modified.

In classical intra mode, where the luma intra prediction mode is to be parsed from the bitstream, an MPM list is constructed using the luma intra modes of neighbouring blocks, which can be unavailable if those blocks were coded using DIMD. In this case, in our contribution, DIMD-coded blocks are treated as inter blocks during MPM list construction, meaning they are effectively considered unavailable.

### 2.15. DIMD

Three angular modes are selected from a Histogram of Gradient (HoG) computed from the neighboring pixels of current block. Once the three modes are selected, their predictors are computed normally and then their weighted average is used as the final predictor of the block. To determine the weights, corresponding amplitudes in the HoG are used for each of the three modes. The DIMD mode is used as an alternative prediction mode and is always checked in the FullRD mode.

Current version of DIMD has modified some aspects in the signaling, HoG computation and the prediction fusion. The purpose of this modification is to improve the coding performance as well as addressing the complexity concerns raised during the last meeting (i.e. throughput of 4×4 blocks). The following sections describe the modifications for each aspect.

Signalling

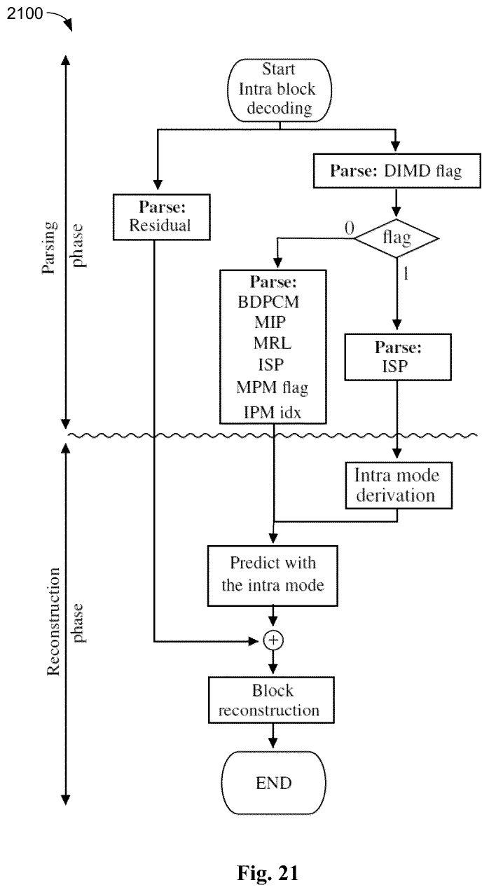

FIG. 21 illustrates a schematic diagram of a proposed intra block decoding process. FIG. 21 shows the order of parsing flags/indices in VTM5, integrated with the proposed DIMD.

As can be seen, the DIMD flag of the block is parsed first using a single CABAC context, which is initialized to the default value of 154.

If flag==0, then the parsing continues normally.

Else (if flag==1), only the ISP index is parsed and the following flags/indices are inferred to be zero: BDPCM flag, MIP flag, MRL index. In this case, the entire IPM parsing is also skipped.

During the parsing phase, when a regular non-DIMD block inquires the IPM of its DIMD neighbor, the mode PLANAR_IDX is used as the virtual IPM of the DIMD block.

Texture Analysis

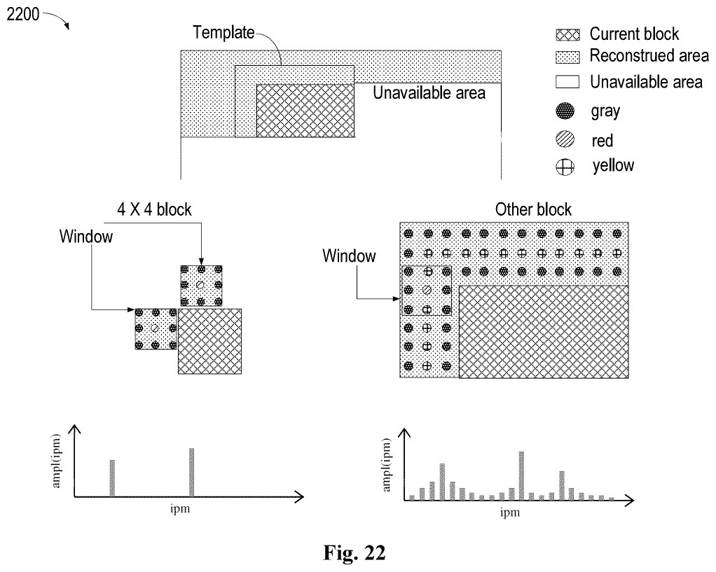

The texture analysis of DIMD includes a Histogram of Gradient (HoG) computation (FIG. 22). The HoG computation is carried out by applying horizontal and vertical Sobel filters on pixels in a template of width 3 around the block. Except, if above template pixels fall into a different CTU, then they will not be used in the texture analysis.

Once computed, the IPMs corresponding to two tallest histogram bars are selected for the block.

In previous versions, all pixels in the middle line of the template were involved in the HoG computation. However, the current version improves the throughput of this process by applying the Sobel filter more sparsely on 4×4 blocks. To this aim, only one pixel from left and one pixel from above are used. This is shown in FIG. 22. FIG. 22 illustrates a schematic diagram of a HoG computation from a template of width 3 pixels.

In addition to reduction in the number of operations for gradient computation, this property also simplifies the selection of best 2 modes from the HoG, as the resulting HoG cannot have more than two non-zero amplitudes.

Prediction Fusion

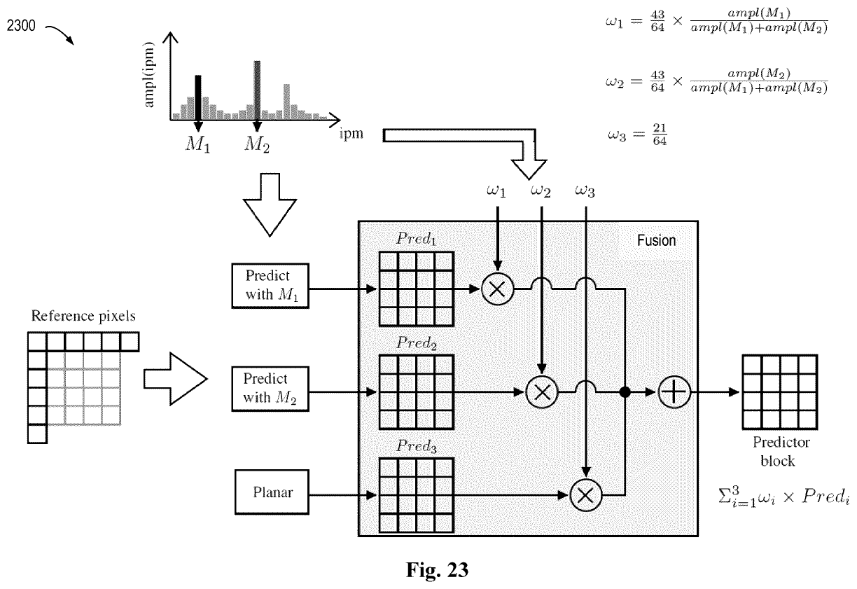

Like the previous version, the current version of the method also uses a fusion of three predictors for each block. However, the choice of prediction modes is different and makes use of the combined hypothesis intra-prediction method is proposed, where the Planar mode is considered to be used in combination with other modes when computing an intra-predicted candidate. In the current version, the two IPMs corresponding to two tallest HoG bars are combined with the Planar mode. The prediction fusion is applied as a weighted average of the above three predictors. To this aim, the weight of planar is fixed to 21/64 (˜⅓). The remaining weight of 43/64 (˜⅔) is then shared between the two HoG IPMs, proportionally to the amplitude of their HoG bars. FIG. 23 visualises this process. FIG. 23 illustrates a schematic diagram of a prediction fusion by weighted averaging of two HoG modes and planar.

### 2.16. Combined Inter and Intra Prediction (CIIP)

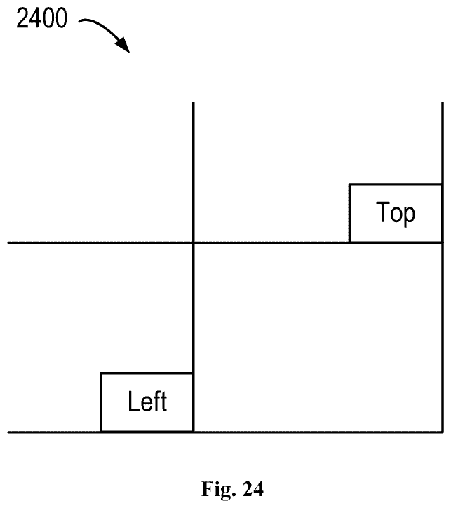

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks (depicted in FIG. 24) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

FIG. 24 illustrates a schematic diagram of top and left neighboring blocks used in CIIP weight derivation. The CIIP prediction is formed as follows:

P_{CIIP}=((4−wt)*Pᵢₙₜₑᵣ+wt*Pᵢₙₜᵣₐ+2)>>2 (2-17)

### 2.17. Geometric Partitioning Mode (GPM)

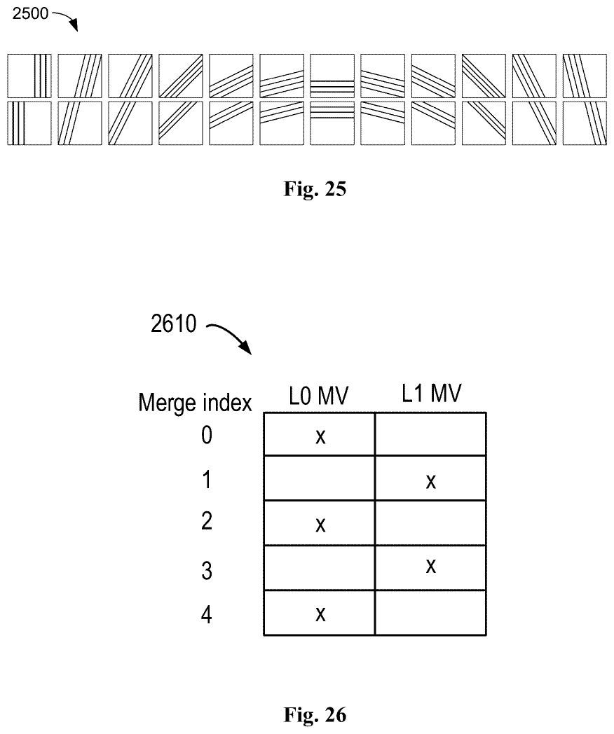

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, nϵ{3 . . . 6} excluding 8×64 and 64×8. When this mode is used, a CU is split into two parts by a geometrically located straight line (as shown in FIG. 25). FIG. 25 illustrates a schematic diagram of examples of the GPM splits grouped by identical angles. The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in 2.17.1.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in 2.17.2. This is the prediction signal for the whole CU, and transform and quantization process will be applied to the whole CU as in other prediction modes. Finally, the motion field of a CU predicted using the geometric partition modes is stored as in 2.17.3.

Uni-Prediction Candidate List Construction

The uni-prediction candidate list is derived directly from the merge candidate list constructed according to the extended merge prediction process in 3.4.1. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 26. FIG. 26 illustrates a schematic diagram of uni-prediction MV selection for geometric partitioning mode. In case a corresponding LX motion vector of the n-the extended merge candidate does not exist, the L(1−X) motion vector of the same candidate is used instead as the uni-prediction motion vector for geometric partitioning mode.

Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 2 - 18 )$$

$${ρ}_{j} = {ρ}_{x , j} cos ( {φ}_{i} ) + {ρ}_{y , j} sin ( {φ}_{i} ) \qquad ( 2 - 19 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 2 - 20 )$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 2 - 21 )$$

where i,j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 2 - 22 )$$

$${w}_{0} ( x , y ) = \frac{Clip 3 ( 0 , 8 , ( wIdxL ( x , y ) + 4 ) ≫ 3 )}{8} \qquad ( 2 - 23 )$$

$${w}_{1} ( x , y ) = 1 - {w}_{0} ( x , y ) \qquad ( 2 - 24 )$$

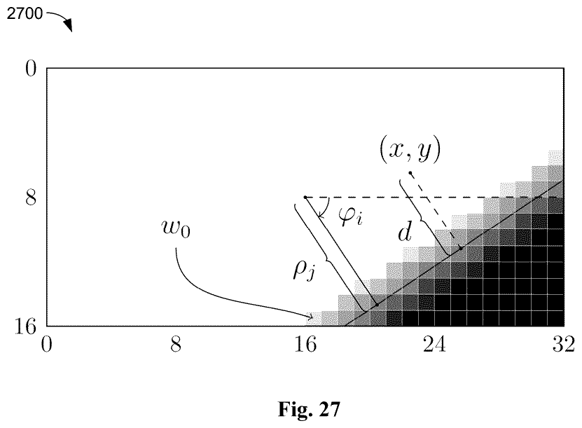

The partIdx depends on the angle index i. One example of weigh w₀ is illustrated in FIG. 27. FIG. 27 illustrates a schematic diagram of exemplified generation of a bending weight w₀ using geometric partitioning mode.

Motion Field Storage for Geometric Partitioning Mode

Mv1 from the first part of the geometric partition, Mv2 from the second part of the geometric partition and a combined My of Mv1 and Mv2 are stored in the motion filed of a geometric partitioning mode coded CU.

The stored motion vector type for each individual position in the motion filed are determined as:

sType=abs(motionIdx)<32?2:(motionIdx≤0?(1−partIdx): partIdx) (2-25)

where motionIdx is equal to d(4x+2, 4y+2), which is recalculated from equation (2-18). The partIdx depends on the angle index i.

If sType is equal to 0 or 1, Mv0 or Mv1 are stored in the corresponding motion field, otherwise if sType is equal to 2, a combined My from Mv0 and Mv2 are stored. The combined My are generated using the following process:
1) If Mv1 and Mv2 are from different reference picture lists (one from L0 and the other from L1), then Mv1 and Mv2 are simply combined to form the bi-prediction motion vectors.

Otherwise, if Mv and Mv2 are from the same list, only uni-prediction motion Mv2 is stored.

### 2.18. Multi-Hypothesis Prediction

In multi-hypothesis prediction (MHP), up to two additional predictors are signalled on top of inter AMVP mode, regular merge mode, affine merge and MMVD mode. The resulting overall prediction signal is accumulated iteratively with each additional prediction signal.

pₙ₊₁=(1−αₙ₊₁)pₙ+αₙ₊₁hₙ₊₁

The weighting factor α is specified according to the following table:

| add_hyp_weight_idx | α |
|---|---|
| 0 | ¼ |
| 1 | −⅛ |

For inter AMVP mode, MHP is only applied if non-equal weight in BCW is selected in bi-prediction mode.

The additional hypothesis can be either merge or AMVP mode. In the case of merge mode, the motion information is indicated by a merge index, and the merge candidate list is the same as in the Geometric Partition Mode. In the case of AMVP mode, the reference index, MVP index, and MVD are signaled.

### 3. Problems

The current design of decoder-side intra prediction mode derivation (DIMD) has the following problems:
1. In the design of DIMD, there are lots of candidate intra prediction modes (IPMs) to derive the optimal IPM for current block, causing high complexity when searching the optimal IPM using the template.
2. The intra prediction modes derived using previously decoded blocks/samples are not combined with other coding tools (e.g., combined inter and intra prediction, geometric partitioning mode, multi-hypothesis prediction, intra block copy), which may limit the coding efficiency.

### 4. Embodiment

The detailed embodiments below should be considered as examples to explain general concepts. These embodiments should not be interpreted in a narrow way. Furthermore, these embodiments can be combined in any manner.

In this disclosure, the term decoder-side intra mode derivation (DIMD) or template-based intra prediction mode (TIMD) represents a coding tool that derives intra prediction mode using previously decoded blocks.

In the disclosure, the “conventional intra prediction mode (IPM) candidate set” is used to indicate the allowed IPMs for intra-coded blocks (e.g., the 35 modes in HEVC, the 67 modes in VVC), and a “conventional intra prediction mode” may refer to an IPM in the conventional IPM candidate set.

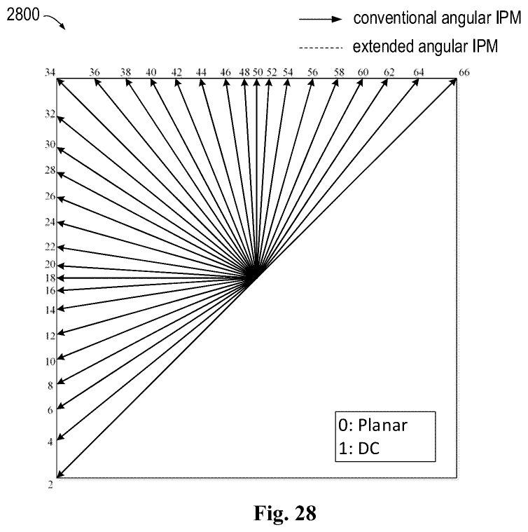

In this disclosure, the “extended intra prediction mode (IPM) candidate set” including all conventional IPMs and extended IPMs (exampled as in FIG. 28). FIG. 28 illustrates a schematic diagram of conventional angular IPMs and extended angular IPMs.

### MPM List Construction for DIMD

1. For a DIMD coded block, it is proposed to derive the optimal IPMs (e.g., the one to be used to code a block) according to a DIMD candidate list wherein the total number of candidates in the DIMD candidate list is smaller than that of the conventional IPM candidate set or extended IPM candidate set.
   a. In one example, the DIMD candidate list is set to an MPM list constructed for DIMD coded blocks (i.e., DIMD MPM list).
      i. In one example, the MPM list for a DIMD coded block may be constructed using the same procedure as the conventional intra prediction.
         1) In one example, the MPM list is constructed using the same way in HEVC, or JEM, or VVC.
         2) In one example, a single MPM list construction process may be defined for a video unit, no matter whether DIMD is used.
      ii. Alternatively, the MPM list for a DIMD coded block may be constructed using a different procedure from the conventional intra prediction.
         1) In one example, more than one MPM list construction processes may be defined for a video unit, in which at least one additional rule is designed especially for DIMD coded block MPM list construction (e.g., DIMD MPM list).
         2) In one example, when a conventional MPM list contains one or more IPMs which are not derived based on the coded information (e.g., IPMs) of neighbouring blocks, such kind of IPMs may be not added to the DIMD MPM list.
         a) In one example, when one or more IPMs are derived using the gradient of neighbouring samples and added to the conventional MPM list, these IPMs may be not added to the DIMD MPM list.
         3) In one example, a subset of the conventional MPM list of current block may be used as the DIMD MPM list.
         a) In one example, when a secondary conventional MPM list is constructed for current block, only the primary conventional MPM list may be used to construct the DIMD MPM list.
         i. Alternatively, IPMs in both primary conventional MPM list and secondary conventional MPM list may be used to construct the DIMD MPM list.
         b) In one example, the first M (e.g., M=6) IPMs in the conventional MPM list may be used to construct DIMD MPM list.
         4) In one example, the number of neighbouring blocks used to construct the DIMD MPM list may be different from (e.g., greater than, or less than) the number of neighbouring blocks used to construct the conventional MPM list for current block.
         a) In one example, when left and above neighbouring blocks are used to construct the conventional MPM list for current block, the left, and/or above, and/or the left-bottom, and/or right-above, and/or left-above neighbouring blocks may be used to construct to the DIMD MPM list.
         5) In one example, the conventional MPM list and DIMD MPM list may be performed using different orders of MPM candidates.
         a) For example, Planar mode may be put in a different order rather than at the first place as in the conventional MPM list.
   b. In one example, the DIMD candidate list size (e.g., the number of candidates in the DIMD candidate list) is set to a pre-defined value or derived on-the-fly.
      i. In one example, the list size is set to K (e.g., K=6 or K=22).
      ii. Alternatively, the list size may be dependent on decoded information of current block and/or its neighbouring blocks (adjacent or non-adjacent).
2. During the DIMD candidate (e.g., MPM) list construction process, a pre-defined IPM may be used as the IPM of a neighbouring block when the neighbouring block is not coded with intra mode (e.g., inter-coded/IBC/PLT mode).
   a. Alternatively, furthermore, the MPM construction process for non-DIMD coded block is applied with the pre-defined IPM treated as a normal intra prediction mode.
3. During the DIMD candidate (e.g., MPM) list construction process, a propagated IPM for a non-intra coded neighbouring block (e.g., inter-coded/IBC/PLT mode) may be used to construct the DIMD candidate list.
   a. In one example, the neighbouring block (adjacent or non-adjacent) may refer to left neighbouring block, and/or above neighbouring block, and/or left-bottom neighbouring block, and/or right-above neighbouring block, and/or left-above neighbouring block.
   b. In one example, the propagated IPM may be derived using the left-top position of the neighbour block, or the center position of the neighbouring block.
   c. In one example, when the neighbouring block is coded with inter mode, the propagated IPM may be derived using motion information of the neighbouring block.
      i. In one example, the motion information may be that associated with the neighbouring block before or after motion refinement (e.g., using a motion vector refinement method (e.g., DMVR)).
      ii. In one example, when there are more than one motion information (e.g, bi-prediction, or two motion information for two parts in TPM/GEO/GPM mode) in the neighbouring block, the propagated IPM may be derived using the first motion information (e.g., L0), or/second motion information (e.g., L1).
      iii. In one example, when each subblock of the neighbouring block has its own motion information (e.g., affine/FRUC/SbTMVP/GPM), the IPM may be derived using the motion information of the subblock.
   d. In one example, when the neighbouring block is coded with IBC mode, the propagated IPM may be derived using block vector of the neighbouring block.
      i. Alternatively, a pre-defined mode may be used as the propagated IPM.
      ii. In one example, a default block vector may be used to derive the propagated IPM.
   e. In one example, pruning may be used when constructing the DIMD candidate (e.g., MPM) list, in which the propagated IPM is not added when it has been in the DIMD candidate list.
   f. In one example, the order of the propagated IPMs added into the MPM list may depend on coded information.
      i. In one example, a propagated IPM of a neighbouring block with non-intra mode may be added as the same order as the neighbouring block with intra mode.
      ii. In one example, all the propagated IPMs may be added after all IPMs derived from neighbouring blocks with intra-coded mode.
      iii. In one example, one or more propagated IPMs may be added before IPMs from neighbouring blocks with intra-coded mode.
         1) In one example, the propagated IPMs of left and above neighbouring blocks may be added before the IPMs of left-bottom/right-above/left-above neighbouring blocks.
   g. Alternatively, furthermore, the DIMD MPM list construction process for non-DIMD coded block is applied with the propagated IPM treated as a normal intra prediction mode.
   h. In one example, the DIMD MPM list may be used for derivation of the optimal IPM for DIMD coded blocks.
4. One or more coding tools used in intra prediction of a non-DIMD block may be not used for the DIMD coded blocks when generating the prediction block of the DIMD coded blocks.
   a. In one example, X-tap interpolation filter used in intra prediction may be not used in the DIMD.
      i. In one example, X is equal to 6, or 8, or 12.
      ii. Alternatively, X-tap interpolation filter used in intra prediction of current block may be used in the DIMD when X is less than or equal to T₁, such as T₁=4 or 2.
   b. In one example, PDPC or Gradient PDPC used in intra prediction of current block may be not used in the DIMD.
   c. In one example, reference sample filtering/smoothing (e.g., MDIS) may be not used for a DIMD coded block.
      i. Alternatively, reference sample filtering/smoothing (e.g., MDIS) may be conditionally applied for a DIMD coded block.
   d. In one example, whether to filter the reference samples for intra prediction in the DIMD may be using the same condition for current block.
      i. Alternatively, the reference samples for intra prediction in the DIMD may be always filtered.
      ii. Alternatively, the reference samples for intra prediction in the DIMD may be not filtered.
5. One or more coding tools used in intra prediction of a non-DIMD block may be not used during the optimal IPM selection for DIMD coded blocks.
   a. In one example, methods mentioned in bullet 4 may be applied during the optimal IPM selection for DIMD coded blocks.

### On Signalling of DIMD (TIMD)

6. Whether DIMD (TIMD) is used/enabled and/or how to use DIMD (TIMD) may be signalled as a syntax element.
   a. In one example, a syntax element (e.g., gci_no_dimd_constraint_flag or gci_no_imd_constraint_flag) may be signalled in general constraints information syntax.
      i. In one example, when the syntax element indicating general constraint on DIMD (TIMD) is equal to X (e.g., X=0 or X=1), DIMD (TIMD) shall be not used.
   b. In one example, a syntax element indicating whether DIMD (TIMD) is enabled may be signalled at sequence header/picture header/SPS/VPS/DPS/DCI/PPS/APS/slice header/tile group header.
      i. In one example, a syntax element (e.g., sps_dimd_enabled_flag or sps_timd_enabled_flag) may be signalled in SPS wherein DIMD/TIMD is enabled when the syntax element is equal to X (e.g., X=0 or X=1).
   c. In one example, a syntax element (e.g, dimd_flag or timd_flag) may be signalled to indicate whether DIMD (TIMD) is used for a video unit (e.g., CU or TU).
      i. In one example, the syntax element may be not signalled and inferred to be X (e.g., X=0) when a coding tool is used for the video unit.
         1) In one example, the coding tool may refer to DIMD, and/or BDPCM, and/or PLT, and/or IBC, and/or MIP.
      ii. In one example, when DIMD (TIMD) is used for the video unit, one or more syntax elements may be not signalled.
         1) In one example, when DIMD (TIMD) is used for the video unit, one or more syntax elements indicating whether coding tools may be not signalled.
         a) In one example, the coding tools may refer to all intra coding tools except for DIMD (TIMD).
         b) In one example, the coding tools may refer to DIMD, and/or BDPCM, and/or PLT, and/or IBC, and/or MIP, and/or ISP, and/or MRL.
         2) In one example, when DIMD (TIMD) is used for the video unit, the remaining syntax elements (e.g., MPM flag, Planar flag, MPM index, MPM remainder index) for luma intra prediction modes may be not signalled.

### Interaction Between Derived Intra Prediction Modes and Inter Coding Tools

7. It is proposed to use derived intra prediction modes combined with an inter coding tool to get the prediction and/or reconstruction of a video unit.
   a. In one example, the intra prediction modes may be derived using the neighbouring adjacent and/or non-adjacent reconstructed samples.
      i. In one example, the intra prediction modes may be derived using DIMD and/or TIMD claimed in above bullets.
      ii. In one example, the intra prediction modes may be derived and/or selected adaptively from more than one intra prediction mode derivation methods (e.g., DIMD and TIMD).
   b. In one example, the inter coding tool may refer to a coding method which gets the final prediction and/or reconstruction using more than one predicted signals.
      i. In one example, the inter coding tool may refer to combined inter and intra prediction (e.g., CIIP), and/or a coding method which splits the video unit into multiple sub-partitions for prediction (e.g., GPM/GEO/TPM), and/or a coding method combing different predicted signal to get the final prediction for the video unit (e.g., multiple hypothesis prediction (MHP)), and/or other inter coding tools.
      ii. In one example, when the derived intra prediction modes are combined with combination inter and intra prediction (e.g., CIIP), the intra predicted signal may be obtained using the derived intra prediction modes and/or one or more pre-defined modes (e.g., Planar).
         1) In one example, the combination may be used an additional mode together with CIIP.
      iii. In one example, when the derived intra prediction modes are combined with the coding method which splits the video unit into multiple sub-partitions for prediction (e.g., GPM/GEO/TPM), the prediction of one or more sub-partitions may be obtained using the derived intra prediction modes.
         1) In one example, the prediction of which sub-partition is obtained using the derived intra prediction modes may be pre-defined, and/or signalled, determined using the coding information.
         2) In one example, the prediction of which sub-partition is obtained using the derived intra prediction modes may be signalled.
         3) In one example, the prediction of which sub-partition is obtained using the derived intra prediction modes may be determined using the coding information.
         a) In one example, the coding information may refer to the dimensions and/or the sizes of current video unit and/or neighbouring video units.
         b) In one example, the coding information may refer to the distances between the sub-partition and neighbouring video units.
      i. In one example, the prediction of a sub-partition which is adjacent to one or more video units may be obtained using the derived intra prediction modes.
      iv. In one example, when the derived intra prediction modes are combined with the coding method combing different predicted signals to get the final prediction (e.g., MHP), one or more predicted signals may be obtained using the derived intra prediction modes.
         1) In one example, the predicted signals obtained using the derived intra prediction modes may be put a pre-defined order to get the final prediction iteratively.
         a) In one example, the predicted signals obtained using the derived intra prediction modes may be put at the first position.
         b) Alternatively, the predicted signal obtained using the derived intra prediction modes may be put at the last position.
         2) In one example, when one of the predicted signals obtained using the derived intra prediction modes, the final prediction may be blended by weighting all hypothesis at the same time, rather than iteratively.
         3) In one example, the predicted signal obtained using the derived intra prediction modes may be blended with a hypothesis first, then used to get the final prediction.
      v. In one example, the claims in bullets ii, iii, iv may be applied to combination with CIIP, and/or GEO/GPM/TPM, and/or MHP.
   c. In one example, one or more intra prediction modes may be derived and used in combination with the inter coding tools.
      i. In one example, the predicted signal may be obtained using one of the derived intra prediction modes.
      ii. In one example, the predicted signal may be obtained by blending multiple predicted signals using more than one derived intra prediction modes.
      iii. In one example, the predicted signal may be obtained by blending multiple predicted signals using one or more derived intra prediction modes and pre-defined modes (e.g., Planar).
   d. In one example, when the derived intra prediction modes are combined with the inter coding tools, the weights of intra part and/or the weights of inter part may be dependent on the coding information.
      i. In one example, the weights of intra part may be larger than, and/or equal to, and/or less than the weights of inter part.
      ii. In one example, the weights may be dependent on the coding modes of neighbouring video units.
      iii. In one example, the weights may be dependent on a variable M, which is obtained during the derivation of the intra prediction modes.
      iv. In one example, the weights of intra part may be same as, or different from the intra part obtained using traditional intra prediction mode.
      v. Alternatively, the weights may be pre-defined.
      vi. Alternatively, the weights may be signalled.
8. The first DIMD/TIMD candidate set used to derive the intra prediction modes combined with the inter coding tool may be same as, and/or different from the second DIMD/TIMD candidate set used in intra prediction of an intra-coded video unit.
   a. In one example, the mode number of the first candidate set may be less than the mode number of the second candidate set.
   b. In one example, the first candidate set may be derived adaptively and dependent on the coding information.
      i. In one example, the coding information may refer to the dimension, and/or size of current video unit, picture, adjacent and/or non-adjacent neighbouring video units.
      ii. In one example, the coding information may refer to the coding modes of current video unit, and/or adjacent and/or non-adjacent neighbouring video units.
9. Whether to and/or how to enable the combination of the derived intra prediction modes and the inter coding tool may be signalled in the bitstream.
   a. In one example, one or more syntax elements may be signalled and used to indicate whether the combination of the derived intra prediction modes and the inter coding tool is enabled.
      i. Indication of the combination may be conditionally signalled wherein the condition may include:
         1) whether the intra prediction modes can be derived and/or the inter coding tool is allowed.
         2) block dimensions and/or block size.
         3) block depth.
         4) slice/picture type and/or partition tree type (single, or dual tree, or local dual tree).
         5) block location.
         6) colour component.
      ii. In one example, the one or more syntax elements may be signalled at sequence header/picture header/SPS/VPS/DPS/DCI/PPS/APS/slice header/tile group header.
   b. In one example, whether the combination is allowed for a video unit may depend on one or more syntax elements.
   c. Alternatively, whether to and/or enable the combination of the derived intra prediction modes and the inter coding tool may be not signalled and determined using the coding information.
10. The first derivation process of intra prediction modes used in the inter coding tools may be same as, or different from the second derivation process of the intra prediction modes used in intra-coded blocks.
11. In one example, the first process to get the predicted signal using the derived intra prediction mode may be same as, or different from the second process to get the predicted signal using the traditional intra prediction mode.
   a. In one example, the reference samples in the first process may be always filtered, and/or unfiltered.
   b. In one example, the filters for filtering the reference samples may be different.
   c. In one example, position dependent prediction combination (PDPC) and/or gradient PDPC may be not used in the first process.
   d. In one example, the intra interpolation filters may be different.
12. In one example, it is proposed to combine the derived intra prediction modes with a coding method in which the reference (or prediction) block is obtained with samples in the current picture (e.g., intra block copy (IBC)).
13. In one example, the combination between the derived intra prediction modes and the inter coding tool may be dependent on colour components.
   a. In one example, different intra prediction modes may be derived for different colour components and used in combination with the inter coding tool.
   b. In one example, intra prediction modes may be derived for a first colour component, a pre-defined intra prediction mode may be used for a second colour component.
      i. In one example, the pre-defined mode may refer to Planar, and/or DC, and/or direct mode.
      ii. In one example, the first component may refer to Y, and the second component may refer to Cb, and/or Cr in YCbCr colour format.
      iii. In one example, the first component may refer to Y, and/or Cb, and/or Cr, and the second component may refer to Y, and/or Cb, and/or Cr in YCbCr colour format.
      iv. In one example, the first component may refer to G, and the second component may refer to B, and/or R in RGB colour format.
      v. In one example, the first component may refer to G, and/or B, and/or R, and the second component may refer to G, and/or B, and/or R in RGB colour format.
   c. In one example, the combination may be not allowed for a colour component and the prediction for the colour component may be obtained using either the derived intra prediction modes or the inter coding tool.
14. Whether to and/or how to apply the disclosed method (e.g., interaction between the derived intra prediction modes and inter coding tools, bullets from 7 to 13) may be signalled at sequence level/group of pictures level/picture level/slice level/tile group level, such as in sequence header/picture header/SPS/VPS/DPS/DCI/PPS/APS/slice header/tile group header.
15. Whether to and/or how to apply the disclosed method (e.g., interaction between the derived intra prediction modes and inter coding tools, bullets from 7 to 13) may be signalled at PB/TB/CB/PU/TU/CU/VPDU/CTU/CTU row/slice/tile/sub-picture/other kinds of region contains more than one sample or pixel.
16. Whether to and/or how to apply the disclosed method (e.g., interaction between the derived intra prediction modes and inter coding tools, bullets from 7 to 13) may be dependent on coded information, such as block size, colour format, single/dual tree partitioning, colour component, slice/picture type.

### General Claims

17. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
18. Whether to and/or how to apply the disclosed methods above may be signalled at PB/TB/CB/PU/TU/CU/VPDU/CTU/CTU row/slice/tile/sub-picture/other kinds of region contains more than one sample or pixel.
19. Whether to and/or how to apply the disclosed methods above may be dependent on coded information, such as block size, colour format, single/dual tree partitioning, colour component, slice/picture type.

### 5. Exemplary Embodiments

Below are some example embodiments for some of the aspects summarized above in Section 4.

### 5.1. Embodiment 1

TIMD Mode Derivation

For each intra prediction mode in MPMs, The SATD between the prediction and reconstruction samples of the template is calculated. The intra prediction mode with the minimum SATD is selected as the TIMD mode and used for intra prediction of current CU. Position dependent intra prediction combination (PDPC) is included in the derivation of the TIMD mode.

TIMD Signalling

A flag is signalled in sequence parameter set (SPS) to enable/disable the proposed method. When the flag is true, a CU level flag is signalled to indicate whether the proposed TIMD method is used. The TIMD flag is signalled right after the MIP flag. If the TIMD flag is equal to true, the remaining syntax elements related to luma intra prediction mode, including MRL, ISP, and normal parsing stage for luma intra prediction modes, are all skipped.

Interaction with New Coding Tools

A DIMD method with prediction fusion using Planar was integrated. When DIMD flag is equal to true, the proposed TIMD flag is not signalled and set equal to false.

Similar to PDPC, Gradient PDPC is also included in the derivation of the TIMD mode.

When secondary MPM is enabled, both the primary MPMs and the secondary MPMs are used to derive the TIMD mode.

6-tap interpolation filter is not used in the derivation of the TIMD mode.

Modification of MPM List Construction in the Derivation of TIMD Mode

During the construction of MPM list, intra prediction mode of a neighbouring block is derived as Planar when it is inter-coded. To improve the accuracy of MPM list, when a neighbouring block is inter-coded, a propagated intra prediction mode is derived using the motion vector and reference picture and used in the construction of MPM list. This modification is only applied to the derivation of TIMD mode.

The embodiments of the present disclosure are related to a combination of derived intra modes and an inter coding tool or other coding tools. As used herein, the term “block” may represent a coding tree block (CTB), a coding tree unit (CTU), a coding block (CB), a coding unit (CU), a prediction unit (PU), a transform unit (TU), a prediction block (PB), a transform block (TB), a video processing unit comprising multiple samples/pixels, and/or the like. A block may be rectangular or non-rectangular.

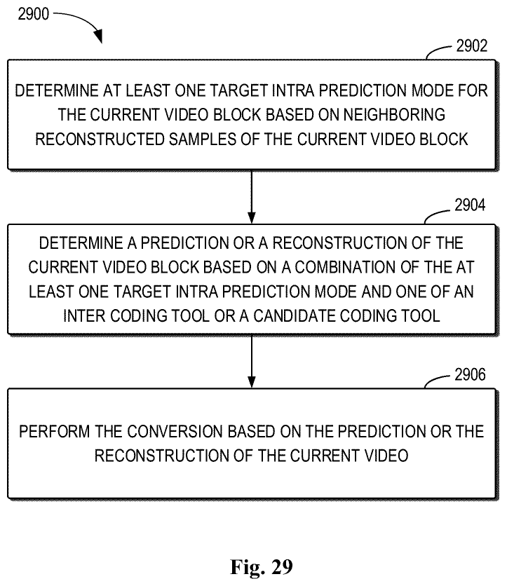

FIG. 29 illustrates a flowchart of a method 2900 for video processing in accordance with some embodiments of the present disclosure. The method 2900 may be implemented during a conversion between a current video block of a video and a bitstream of the video. As shown in FIG. 29, the method 2900 starts at 2902 where at least one target intra prediction mode for the current video block is determined based on neighboring reconstructed samples of the current video block. By way of example, with reference to FIG. 18, reconstructed samples 1820 and 1822 neighboring to the current video block 1810 may be used to determine at least one target intra prediction mode for the current video block 1810 based on decoder-side intra mode derivation (DIMD).

At 2904, a prediction or a reconstruction of the current video block is determined based on a combination of the at least one target intra prediction mode and one of an inter coding tool or a candidate coding tool. The candidate coding tool is used for determining a reference block for the current video block with samples in a current picture associated with the current video block. In some embodiments, the candidate coding tool may comprise an intra block copy (IBC). With reference to FIG. 18, in one example, a prediction of the current video block 1810 may be determined by using the at least one target intra prediction mode and an inter coding tool, e.g., CIIP. In another example, a reconstruction of the current video block 1810 may be determined by using the at least one target intra prediction mode and IBC. It should be understood that the above illustrations and/or examples are described merely for purpose of description. The scope of the present disclosure is not limited in this respect.

At 2906, the conversion is performed based on the prediction or the reconstruction of the current video. In some embodiments, the conversion may include encoding the current video block into the bitstream. Alternatively or additionally, the conversion may include decoding the current video block from the bitstream.

The method 2900 combines an intra prediction mode derived using previously coded blocks or samples with other coding tools. Thereby, the proposed method can advantageously improve coding efficiency and coding quality.

In some embodiments, the neighboring reconstructed samples may comprise reconstructed samples adjacent to the current video block and/or reconstructed samples non-adjacent to the current video block. By way of example, in FIG. 18, reconstructed samples 1820 and 1822 which are adjacent to the current video block 1810 are used as the neighboring reconstructed samples for determining the at least one target intra prediction mode. It should be understood that the above illustrations and/or examples are described merely for purpose of description. The scope of the present disclosure is not limited in this respect.

In some embodiments, at block 2902, the at least one target intra prediction mode may be determined by using decoder-side intra mode derivation (DIMD). Alternatively or additionally, the at least one target intra prediction mode may be determined by using template-based intra mode derivation (TIMD). By way of example, with reference to FIG. 18, the at least one target intra prediction mode for the current video block 1810 is determined based on DIMD by using reconstructed samples 1820 and 1822. It should be understood that the above illustrations and/or examples are described merely for purpose of description. The scope of the present disclosure is not limited in this respect.

In some embodiments, the at least one target intra prediction mode may be determined from a plurality of coding tools for determining an intra prediction mode. In one example, the at least one target intra prediction mode may be derived adaptively from DIMD and TIMD. Alternatively or additionally, the at least one target intra prediction mode may be selected adaptively from DIMD and TIMD.

In some embodiments, the inter coding tool may comprise a target coding tool for determining the prediction or the reconstruction of the current video based on a plurality of predicted signals. In one embodiment, the target coding tool may comprise at least one of: combined inter and intra prediction (CIIP), a first coding tool for splitting the current video unit into multiple sub-partitions for prediction, or a second coding tool for combing different predicted signals to obtain the prediction of the current video unit. For example, the first coding tool may comprise a geometric partitioning mode (GPM) or a triangle partition mode (TPM). The second coding tool may comprise a multiple hypothesis prediction (MHP). It should be understood that the possible implementations of the first coding tool and the second coding tool described here are merely illustrative and therefore should not be construed as limiting the present disclosure in any way.

In some embodiments, the target coding tool may comprise the CIIP, and an intra predicted signal may be obtained based on the at least one target intra prediction mode. Additionally or alternatively, the intra predicted signal may be obtained based on at least one predefined intra prediction mode. Thereby, the proposed method can advantageously improve coding efficiency and coding quality. In one embodiment, the at least one predefined intra prediction mode may comprise a planar mode. It should be understood that the at least one predefined intra prediction mode may comprise any other suitable intra prediction mode. The scope of the present disclosure is not limited in this respect.

In some embodiments, the combination of the at least one target intra prediction mode and one of the inter coding tool or the candidate coding tool may be used in addition to CIIP. In some embodiments, in addition to the CIIP, the target coding tool may further comprise the first coding tool. Additionally or alternatively, the target coding tool may further comprise the second coding tool.

In some embodiments, the target coding tool may comprise the first coding tool, and a prediction of at least one target sub-partition of the multiple sub-partitions may be determined based on the at least one target intra prediction mode. Thereby, the proposed method can advantageously improve coding efficiency and coding quality. In one example, the at least one target sub-partition may be pre-defined. Alternatively, the at least one target sub-partition may be indicated in the bitstream. In yet another example, the at least one target sub-partition may be determined based on coding information of the video.

In some embodiments, the coding information may comprise at least one of: a dimension of the current video unit, a size of the current video unit, a dimension of at least one neighboring video unit of the current video unit, or a size of the at least one neighboring video unit. In another embodiment, the coding information may comprise a distance between the target sub-partition and at least one neighboring video unit of the current video unit. In this case, a sub-partition adjacent to the at least one neighboring video unit of the current video unit may be determined as the at least one target sub-partition. That is, the at least one target sub-partition may be adjacent to the at least one neighboring video unit of the current video unit. It should be understood that the coding information may comprise any other suitable information. The scope of the present disclosure is not limited in this respect.

In some embodiments, in addition to the first coding tool, the target coding tool may further comprise the CIIP. Additionally or alternatively, the target coding tool may further comprise the second coding tool.

In some embodiments, the target coding tool may comprise the second coding tool, and at least one predicted signal may be determined based on the at least one target intra prediction mode. Thereby, the proposed method can advantageously improve coding efficiency and coding quality. In one example, the at least one predicted signal may be assigned with a predefined order of iteration for determining the prediction of the current video block. That is, each of the at least one predicted signal may be used to determine the prediction of the current video block in certain predefined iteration. For example, one of the at least one predicted signal may be used in the first iteration. Alternatively or additionally, one of the at least one predicted signal may be used in the last iteration.

In some embodiments, at 2904, the prediction of the current video block may be determined by weighting all of candidate predicted signals for the current video block. The candidate predicted signals comprising one of the at least one predicted signal. For example, in case that MHP is employed, the final prediction of the current video block may be determined by weighting all hypotheses at the same time, rather than iteratively.

In some embodiments, at 2904, a weighted predicted signal is obtained by weighting one of the at least one predicted signal and one of a plurality of candidate predicted signals for the current video block. The prediction of the current video block is determined based on the weighted predicted signal and remaining ones of the plurality of candidate predicted signals. For example, a predicted signal may be added with a hypothesis first, and then used to determine the final prediction.

In some embodiments, in addition to the second coding tool, the target coding tool may further comprise the CIIP. Additionally or alternatively, the target coding tool may further comprise the first coding tool.

In some embodiments, the at least one target intra prediction mode may comprise a plurality of target intra prediction modes. Thereby, several different intra prediction modes can be used for determine the prediction or the reconstruction of the current video block, which can advantageously improve the coding quality.

In some embodiments, at 2904, a predicted signal may be determined based on one of the plurality of target intra prediction modes. The prediction or the reconstruction of the current video block may be determined based on the predicted signal.

In some embodiments, at 2904, multiple predicted signals may be determined based on at least two of the plurality of target intra prediction modes. A weighted signal may be obtained by weighting the multiple predicted signals, and the prediction or the reconstruction of the current video block may be determined based on the weighted signal. Thereby, several different intra prediction modes can be used for determine the prediction or the reconstruction of the current video block, which can advantageously improve the coding quality.

In some embodiments, at 2904, predicted signals may be determined based on a set of intra prediction modes. The set of intra prediction modes may comprise a predefined intra prediction mode and at least one of the plurality of target intra prediction modes. A weighted signal may be obtained by weighting the predicted signals and the prediction or the reconstruction of the current video block may be determined based on the weighted signal. Thereby, several different intra prediction modes can be used for determine the prediction or the reconstruction of the current video block, which can advantageously improve the coding quality.

In some embodiments, at 2904, an intra part for the prediction of the current video block may be determined based on the at least one target intra prediction mode. An inter part for the prediction of the current video block may be determined based on the inter coding tool, and the prediction may be determined by weighting the intra part and the inter part with a first weight for the intra prat and a second weight for the inter part. Alternatively, an inter part for the prediction of the current video block may be determined based on the candidate coding tool, and the prediction may be determined by weighting the intra part and the inter part with a first weight for the intra prat and a second weight for the inter part. The first weight may be dependent on coding information of the video. Additionally or alternatively, the second weight may be dependent on coding information of the video.

In some embodiments, at 2904, an intra part for the reconstruction of the current video block may be determined based on the at least one target intra prediction mode. An inter part for the reconstruction of the current video block may be determined based on the inter coding tool, and the reconstruction may be determined by weighting the intra part and the inter part with a first weight for the intra prat and a second weight for the inter part. Alternatively, an inter part for the reconstruction of the current video block may be determined based on the candidate coding tool, and the reconstruction may be determined by weighting the intra part and the inter part with a first weight for the intra prat and a second weight for the inter part. The first weight may be dependent on coding information of the video. Additionally or alternatively, the second weight may be dependent on coding information of the video.

In some embodiments, the first weight may be larger than the second weight. Alternatively, the first weight may be equal to the second weight. In another embodiment, the first weight may be smaller than the second weight.

In some embodiments, at 2904, an intra part for the prediction of the current video block may be determined based on the at least one target intra prediction mode. An inter part for the prediction of the current video block may be determined based on the inter coding tool, and the prediction may be determined by weighting the intra part and the inter part with a first weight for the intra prat and a second weight for the inter part. Alternatively, an inter part for the prediction of the current video block may be determined based on the candidate coding tool, and the prediction may be determined by weighting the intra part and the inter part with a first weight for the intra prat and a second weight for the inter part. The first weight may be dependent on coding mode of a neighboring video unit of the current video unit. Additionally or alternatively, the second weight may be dependent on coding mode of a neighboring video unit of the current video unit.

In some embodiments, at 2904, an intra part for the reconstruction of the current video block may be determined based on the at least one target intra prediction mode. An inter part for the reconstruction of the current video block may be determined based on the inter coding tool, and the reconstruction may be determined by weighting the intra part and the inter part with a first weight for the intra prat and a second weight for the inter part. Alternatively, an inter part for the reconstruction of the current video block may be determined based on the candidate coding tool, and the reconstruction may be determined by weighting the intra part and the inter part with a first weight for the intra prat and a second weight for the inter part. The first weight may be dependent on coding mode of a neighboring video unit of the current video unit. Additionally or alternatively, the second weight may be dependent on coding mode of a neighboring video unit of the current video unit.

In some embodiments, at 2904, an intra part for the prediction of the current video block may be determined based on the at least one target intra prediction mode. An inter part for the prediction of the current video block may be determined based on the inter coding tool, and the prediction may be determined by weighting the intra part and the inter part with a first weight for the intra prat and a second weight for the inter part. Alternatively, an inter part for the prediction of the current video block may be determined based on the candidate coding tool, and the prediction may be determined by weighting the intra part and the inter part with a first weight for the intra prat and a second weight for the inter part. The first weight may be dependent on a variable obtained during the determination of the at least one target intra prediction mode. Additionally or alternatively, the second weight may be dependent on a variable obtained during the determination of the at least one target intra prediction mode. By way of example, the variable may be the direction associated with the intra prediction mode. It should be understood that the possible implementation of the variable described here is merely illustrative and therefore should not be construed as limiting the present disclosure in any way.

In some embodiments, at 2904, an intra part for the reconstruction of the current video block may be determined based on the at least one target intra prediction mode. An inter part for the reconstruction of the current video block may be determined based on the inter coding tool, and the reconstruction may be determined by weighting the intra part and the inter part with a first weight for the intra prat and a second weight for the inter part. Alternatively, an inter part for the reconstruction of the current video block may be determined based on the candidate coding tool, and the reconstruction may be determined by weighting the intra part and the inter part with a first weight for the intra prat and a second weight for the inter part. The first weight may be dependent on a variable obtained during the determination of the at least one target intra prediction mode. Additionally or alternatively, the second weight may be dependent on a variable obtained during the determination of the at least one target intra prediction mode. By way of example, the variable may be the direction associated with the intra prediction mode. It should be understood that the possible implementation of the variable described here is merely illustrative and therefore should not be construed as limiting the present disclosure in any way.

In some embodiments, the first weight may be the same as a weight for an intra part obtained based on an intra prediction mode indicated in the bitstream. Alternatively, the first weight may be different from the weight for an intra part obtained based on an intra prediction mode indicated in the bitstream.

In some embodiments, at 2904, an intra part for the prediction of the current video block may be determined based on the at least one target intra prediction mode. An inter part for the prediction of the current video block may be determined based on the inter coding tool, and the prediction may be determined by weighting the intra part and the inter part with a first weight for the intra prat and a second weight for the inter part. Alternatively, an inter part for the prediction of the current video block may be determined based on the candidate coding tool, and the prediction may be determined by weighting the intra part and the inter part with a first weight for the intra prat and a second weight for the inter part. At least one of the first weight or the second weight may be pre-defined. Alternatively, the at least one of the first weight or the second weight may be indicated in the bitstream.

In some embodiments, at 2904, an intra part for the reconstruction of the current video block may be determined based on the at least one target intra prediction mode. An inter part for the reconstruction of the current video block may be determined based on the inter coding tool, and the reconstruction may be determined by weighting the intra part and the inter part with a first weight for the intra prat and a second weight for the inter part. Alternatively, an inter part for the reconstruction of the current video block may be determined based on the candidate coding tool, and the reconstruction may be determined by weighting the intra part and the inter part with a first weight for the intra prat and a second weight for the inter part. At least one of the first weight or the second weight may be pre-defined. Alternatively, the at least one of the first weight or the second weight may be indicated in the bitstream.

In some embodiments, the at least one target intra prediction mode may be determined from a first set of candidate intra prediction modes. In one example, the first set of candidate intra prediction modes may be the same as a second set of candidate intra prediction modes for intra prediction of an intra-coded video unit. By way of example, both the first set of candidate intra prediction modes and the second set of candidate intra prediction modes may comprise 67 intra prediction modes. Alternatively, the first set of candidate intra prediction modes may be different from a second set of candidate intra prediction modes for intra prediction of an intra-coded video unit. By way of example, the first set of candidate intra prediction modes may comprise 67 intra prediction modes, while the second set of candidate intra prediction modes may comprise 30 intra prediction modes. It should be understood that the above illustrations and/or examples are described merely for purpose of description. The scope of the present disclosure is not limited in this respect.

In some embodiments, a number of candidate intra prediction modes in the first set of candidate intra prediction modes may be less than a number of candidate intra prediction modes in the second set of candidate intra prediction modes. By way of example, the second set of candidate intra prediction modes may comprise 67 intra prediction modes, while the first set of candidate intra prediction modes may comprise only 20 intra prediction modes. Thereby, it is possible to reduce the time required for determining the at least one intra prediction mode. Thus, the coding efficiency may be improved. It should be understood that the above illustrations and/or examples are described merely for purpose of description. The scope of the present disclosure is not limited in this respect.

In some embodiments, the first set of candidate intra prediction modes may be determined based on coding information of the video. For example, the coding information may comprise at least one of: a dimension of the current video unit, a size of the current video unit, a dimension of a current picture associate with the current video unit, a size of the current picture, a dimension of at least one adjacent video unit of the current video unit, a size of the at least one adjacent video unit, a dimension of at least one non-adjacent video unit of the current video unit, a size of the at least one non-adjacent video unit. a coding mode of the current video unit, a coding mode of the adjacent video unit, or a coding mode of the non-adjacent video unit. It should be understood that the coding information may comprise any other suitable information. The scope of the present disclosure is not limited in this respect.

In some embodiments, whether to enable the combination of the at least one target intra prediction mode and one of the inter coding tool or the candidate coding tool may be indicated in the bitstream. Additionally or alternatively, how to enable the combination of the at least one target intra prediction mode and one of the inter coding tool or the candidate coding tool may be indicated in the bitstream.

In some embodiments, at least one syntax element may be used to indicate whether the combination of the at least one target intra prediction mode and one of the inter coding tool or the candidate coding tool may be enabled.

In some embodiments, whether the combination of the at least one target intra prediction mode and one of the inter coding tool or the candidate coding tool may be enabled may be indicated in the bitstream based on whether the at least one target intra prediction mode intra prediction modes can be determined. Additionally or alternatively, whether the combination of the at least one target intra prediction mode and one of the inter coding tool or the candidate coding tool may be enabled may be indicated in the bitstream based on whether the inter coding tool or the candidate coding tool may be allowed. In yet another embodiment, whether the combination of the at least one target intra prediction mode and one of the inter coding tool or the candidate coding tool may be enabled may be indicated in the bitstream based on a dimension of the current video block. Additionally or alternatively, whether the combination of the at least one target intra prediction mode and one of the inter coding tool or the candidate coding tool may be enabled may be indicated in the bitstream based on a size of the current video block. Additionally or alternatively, whether the combination of the at least one target intra prediction mode and one of the inter coding tool or the candidate coding tool may be enabled may be indicated in the bitstream based on a depth of the current video block. In another embodiment, whether the combination of the at least one target intra prediction mode and one of the inter coding tool or the candidate coding tool may be enabled may be indicated in the bitstream based on a type of a current slice associated with the current video block and/or a type of a current picture associated with the current video block. Additionally or alternatively, whether the combination of the at least one target intra prediction mode and one of the inter coding tool or the candidate coding tool may be enabled may be indicated in the bitstream based on a partition tree type associated with the current video block and/or a location of the current video block. In yet another embodiment, whether the combination of the at least one target intra prediction mode and one of the inter coding tool or the candidate coding tool may be enabled may be indicated in the bitstream based on a color component of the current video block.

In some embodiments, the at least one syntax element may be included in a sequence header. Alternatively, the at least one syntax element may be included in a picture header. In another embodiment, the at least one syntax element may be included in a sequence parameter set (SPS). Alternatively, the at least one syntax element may be included in a video parameter set (VPS). In yet another embodiment, the at least one syntax element may be included in a dependency parameter set (DPS). Alternatively, the at least one syntax element may be included in a decoding capability information (DCI). In a further embodiment, the at least one syntax element may be included in a picture parameter set (PPS) or an adaptation parameter sets (APS). Alternatively, the at least one syntax element may be included in a slice header or a tile group header.

In some embodiments, whether the combination of the at least one target intra prediction mode and one of the inter coding tool or the candidate coding tool may be allowed may be dependent on at least one syntax element.

In some embodiments, whether to enable the combination of the at least one target intra prediction mode and one of the inter coding tool or the candidate coding tool may be determined based on coding information of the video. Additionally or alternatively, how to enable the combination of the at least one target intra prediction mode and one of the inter coding tool or the candidate coding tool may be determined based on coding information of the video.

In some embodiments, the at least one target intra prediction mode may be determined based on a first determination process. In one example, the first determination process may be the same as a second determination process for determining intra prediction modes for an intra-coded video unit. Alternatively, the first determination process may be different from a second determination process for determining intra prediction modes for an intra-coded video unit.

In some embodiments, at 2904, a predicted signal may be determined based at least on one of the at least one target intra prediction modes and a first process, and the prediction or the reconstruction of the current video block may be determined based on the predicted signal. In one example, the first process may be the same as a second process for determining a predicted signal based on an intra prediction mode indicated in the bitstream. Alternatively, the first process may be different from a second process for determining a predicted signal based on an intra prediction mode indicated in the bitstream.

In some embodiments, at least one reference samples in the first process may be filtered. Alternatively, at least one reference samples in the first process may be unfiltered. In some embodiments, a filter for filtering a reference sample in the first process may be different from a filer for filtering a reference sample in the second process. In some embodiments, the first process may be performed without position dependent prediction combination (PDPC). Additionally or alternatively, the first process may be performed without gradient PDPC. In some embodiments, an intra interpolation filter used in the first process may be different from an intra interpolation filter used in the second process.

In some embodiments, the combination of the at least one target intra prediction mode and one of the inter coding tool or the candidate coding tool may be dependent on a color component of the current video block. For example, a target intra prediction mode determined for a first color component may be different from a target intra prediction mode determined for a second color component different from the first color component. In another example, a target intra prediction mode may be determined for a first color component, while a pre-defined intra prediction mode may be used for a second color component different from the first color component. By way of example, the predefined intra prediction mode may comprise a planar mode. Additionally or alternatively, the predefined intra prediction mode may comprise a DC mode. In addition, the predefined intra prediction mode may comprise a direct mode. It should be understood that the above illustrations and/or examples are described merely for purpose of description. The scope of the present disclosure is not limited in this respect.

In some embodiments, the current video block may be coded in YCbCr color format, the YCbCr color format may comprise a luma component, a first chroma component and a second chroma component different from the first chroma component. The first color component may be the luma component, and the second color component may be the first chroma component or the second chroma component. For example, the first color component may be the luma component Y, while the second color component may be the chroma component Cb. Alternatively, the first color component may be the luma component Y, while the second color component may be the chroma component Cr.

In some embodiments, the current video block may be coded in YCbCr color format, the YCbCr color format may comprise a luma component, a first chroma component and a second chroma component different from the first chroma component. The first color component may be the first chroma component, and the second color component may be the luma component or the second chroma component. For example, the first color component may be the chroma component Cb, while the second color component may be the luma component Y. Alternatively, the first color component may be the chroma component Cr, while the second color component may be the chroma component Cb. It should be understood that the above illustrations and/or examples are described merely for purpose of description. The scope of the present disclosure is not limited in this respect.

In some embodiments, the current video block may be coded in RGB color format, the RGB color format may comprise a red component, a green component and a blue component. In one example, the first color component may be the green component, and the second color component may be the red component. Alternatively, the first color component may be the green component, and the second color component may be the blue component.

In some embodiments, the current video block may be coded in RGB color format, the RGB color format may comprise a red component, a green component and a blue component. In one example, the first color component may be the red component, and the second color component may be the green component. Alternatively, the first color component may be the red component, and the second color component may be the blue component.

In some embodiments, the current video block may be coded in RGB color format, the RGB color format may comprise a blue component, a green component and a blue component. In one example, the first color component may be the red component, and the second color component may be the green component. Alternatively, the first color component may be the red component, and the second color component may be the red component.

It should be understood that the current video block may also be coded in any other suitable color format, and the above illustrations and/or examples are described merely for purpose of description. The scope of the present disclosure is not limited in this respect.

In some embodiments, the combination of the at least one target intra prediction mode and one of the inter coding tool or the candidate coding tool may be disabled for a first color component of the current video block. At 2904, a prediction for the first color component may be determined for example based on the at least one target intra prediction mode. Alternatively, a prediction for the first color component may be determined based on the inter coding tool. In yet another example, a prediction for the first color component may be determined based on the candidate coding tool.

In some embodiments, at 2904, a first candidate reconstruction of the current video block may be determined based on the at least one target intra prediction mode, and a second candidate reconstruction of the current video block may be determined based on the inter coding tool. The reconstruction of the current video block may be determined based on the first candidate reconstruction and the second candidate reconstruction.

Alternatively, at 2904, a first candidate reconstruction of the current video block may be determined based on the at least one target intra prediction mode, and a second candidate reconstruction of the current video block may be determined based on the candidate coding tool. The reconstruction of the current video block may be determined based on the first candidate reconstruction and the second candidate reconstruction.

In some embodiments, whether to apply the method according to some embodiments of the present disclosure may be indicated at one of: sequence level, group of pictures level, picture level, slice level, or tile group level. Additionally or alternatively, how to apply the method according to some embodiments of the present disclosure may be indicated at one of: sequence level, group of pictures level, picture level, slice level, or tile group level.

In some embodiments, whether to apply the method according to some embodiments of the present disclosure may be indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header. Additionally or alternatively, how to apply the method according to some embodiments of the present disclosure may be indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, whether to apply the method according to some embodiments of the present disclosure may be indicated at one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel. Additionally or alternatively, how to apply the method according to some embodiments of the present disclosure may be indicated at one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel

In some embodiments, the method 2900 may further comprise: determining, based on coded information of the current video unit, whether to and/or how to apply the method according to some embodiments of the present disclosure. The coded information may comprise at least one of: a block size, a colour format, a single dual tree partitioning, a dual tree partitioning, a colour component, a slice type, a picture type, or the like. It should be understood that the above illustrations and/or examples are described merely for purpose of description. The scope of the present disclosure is not limited in this respect.

In some embodiments, a bitstream of a video may be stored in a non-transitory computer-readable recording medium. The bitstream of the video can be generated by a method performed by a video processing apparatus. According to the method, at least one target intra prediction mode for the current video block may be determined based on neighboring reconstructed samples of the current video block. A prediction or a reconstruction of the current video block may be determined based on a combination of the at least one target intra prediction mode and one of an inter coding tool or a candidate coding tool. A bitstream of the current video block may be generated based on the prediction or the reconstruction of the current video.

In some embodiments, at least one target intra prediction mode for the current video block may be determined based on neighboring reconstructed samples of the current video block. A prediction or a reconstruction of the current video block may be determined based on a combination of the at least one target intra prediction mode and one of an inter coding tool or a candidate coding tool. A bitstream of the current video block may be generated based on the prediction or the reconstruction of the current video. The bitstream may be stored in a non-transitory computer-readable recording medium.

Implementations of the present disclosure can be described in view of the following clauses, the features of which can be combined in any reasonable manner.

Clause 1. A method for video processing, comprising: determining, during a conversion between a current video block of a video and a bitstream of the video, at least one target intra prediction mode for the current video block based on neighboring reconstructed samples of the current video block; determining a prediction or a reconstruction of the current video block based on a combination of the at least one target intra prediction mode and one of an inter coding tool or a candidate coding tool, the candidate coding tool being used for determining a reference block for the current video block with samples in a current picture associated with the current video block; and performing the conversion based on the prediction or the reconstruction of the current video.

Clause 2. The method of clause 1, wherein the neighboring reconstructed samples comprise at least one of: reconstructed samples adjacent to the current video block, or reconstructed samples non-adjacent to the current video block.

Clause 3. The method of any of clauses 1-2, wherein determining the at least one target intra prediction mode comprises: determining the at least one target intra prediction mode by using at least one of: decoder-side intra mode derivation (DIMD), or template-based intra mode derivation (TIMD).

Clause 4. The method of any of clauses 1-2, wherein the at least one target intra prediction mode is determined from a plurality of coding tools for determining an intra prediction mode.

Clause 5. The method of any of clauses 1-4, wherein the inter coding tool comprises a target coding tool for determining the prediction or the reconstruction of the current video based on a plurality of predicted signals.

Clause 6. The method of clause 5, wherein the target coding tool comprises at least one of: combined inter and intra prediction (CIIP), a first coding tool for splitting the current video unit into multiple sub-partitions for prediction, or a second coding tool for combing different predicted signals to obtain the prediction of the current video unit.

Clause 7. The method of clause 6, wherein the first coding tool comprises a geometric partitioning mode (GPM) or a triangle partition mode (TPM), or the second coding tool comprises a multiple hypothesis prediction (MHP).

Clause 8. The method of any of clauses 6-7, wherein the target coding tool comprises the CIIP, and an intra predicted signal is obtained based on the at least one target intra prediction mode and/or at least one predefined intra prediction mode.

Clause 9. The method of clause 8, wherein the at least one predefined intra prediction mode comprises a planar mode.

Clause 10. The method of any of clauses 1-9, wherein the combination of the at least one target intra prediction mode and one of the inter coding tool or the candidate coding tool is used in addition to CIIP.

Clause 11. The method of any of clauses 6-7, wherein the target coding tool comprises the first coding tool, and a prediction of at least one target sub-partition of the multiple sub-partitions is determined based on the at least one target intra prediction mode.

Clause 12. The method of clause 11, wherein the at least one target sub-partition is pre-defined, or the at least one target sub-partition is indicated in the bitstream, or the at least one target sub-partition is determined based on coding information of the video.

Clause 13. The method of clause 12, wherein the coding information comprises at least one of: a dimension of the current video unit, a size of the current video unit, a dimension of at least one neighboring video unit of the current video unit, or a size of the at least one neighboring video unit.

Clause 14. The method of clause 12, wherein the coding information comprises a distance between the target sub-partition and at least one neighboring video unit of the current video unit.

Clause 15. The method of clause 14, wherein the at least one target sub-partition is adjacent to the at least one neighboring video unit of the current video unit.

Clause 16. The method of any of clauses 6-7, wherein the target coding tool comprises the second coding tool, and at least one predicted signal is determined based on the at least one target intra prediction mode.

Clause 17. The method of clause 16, wherein the at least one predicted signal is assigned with a predefined order of iteration for determining the prediction of the current video block.

Clause 18. The method of clause 17, wherein one of the at least one predicted signal is used in the first iteration or the last iteration.

Clause 19. The method of clause 16, wherein determining the prediction of the current video block comprises: determining the prediction of the current video block by weighting all of candidate predicted signals for the current video block, the candidate predicted signals comprising one of the at least one predicted signal.

Clause 20. The method of clause 16, wherein determining the prediction of the current video block comprises: obtaining a weighted predicted signal by weighting one of the at least one predicted signal and one of a plurality of candidate predicted signals for the current video block; and determining the prediction of the current video block based on the weighted predicted signal and remaining ones of the plurality of candidate predicted signals.

Clause 21. The method of any of clauses 8-10, wherein the target coding tool further comprises at least one of the first coding tool or the second coding tool.

Clause 22. The method of any of clauses 11-15, wherein the target coding tool further comprises at least one of the CIIP or the second coding tool.

Clause 23. The method of any of clauses 16-20, wherein the target coding tool further comprises at least one of the CIIP or the first coding tool.

Clause 24. The method of any of clauses 1-23, wherein the at least one target intra prediction mode comprises a plurality of target intra prediction modes.

Clause 25. The method of clause 24, wherein determining the prediction or the reconstruction of the current video block comprises: determining a predicted signal based on one of the plurality of target intra prediction modes; and determining the prediction or the reconstruction of the current video block based on the predicted signal.

Clause 26. The method of clause 25, wherein determining the prediction or the reconstruction of the current video block comprises: determining multiple predicted signals based on at least two of the plurality of target intra prediction modes; obtaining a weighted signal by weighting the multiple predicted signals; and determining the prediction or the reconstruction of the current video block based on the weighted signal.

Clause 27. The method of clause 25, wherein determining the prediction or the reconstruction of the current video block comprises: determining predicted signals based on a set of intra prediction modes, the set of intra prediction modes comprising a predefined intra prediction mode and at least one of the plurality of target intra prediction modes; obtaining a weighted signal by weighting the predicted signals; and determining the prediction or the reconstruction of the current video block based on the weighted signal.

Clause 28. The method of any of clauses 1-24, wherein determining the prediction or the reconstruction of the current video block comprises: determining, based on the at least one target intra prediction mode, an intra part for the prediction or the reconstruction of the current video block; determining, based on the inter coding tool or the candidate coding tool, an inter part for the prediction or the reconstruction of the current video block; and determining the prediction or the reconstruction by weighting the intra part and the inter part with a first weight for the intra prat and a second weight for the inter part, at least one of the first weight or the second weight being dependent on coding information of the video.

Clause 29. The method of clause 28, wherein the first weight is larger than, or equal to, or smaller than the second weight.

Clause 30. The method of any of clauses 1-24, wherein determining the prediction or the reconstruction of the current video block comprises: determining, based on the at least one target intra prediction mode, an intra part for the prediction or the reconstruction of the current video block; determining, based on the inter coding tool or the candidate coding tool, an inter part for the prediction or the reconstruction of the current video block; and determining the prediction or the reconstruction by weighting the intra part and the inter part with a first weight for the intra prat and a second weight for the inter part, at least one of the first weight or the second weight being dependent on coding mode of a neighboring video unit of the current video unit.

Clause 31. The method of any of clauses 1-24, wherein determining the prediction or the reconstruction of the current video block comprises: determining, based on the at least one target intra prediction mode, an intra part for the prediction or the reconstruction of the current video block; determining, based on the inter coding tool or the candidate coding tool, an inter part for the prediction or the reconstruction of the current video block; and determining the prediction or the reconstruction by weighting the intra part and the inter part with a first weight for the intra prat and a second weight for the inter part, at least one of the first weight or the second weight being dependent on a variable obtained during the determination of the at least one target intra prediction mode.

Clause 32. The method of any of clauses 28-31, wherein the first weight is the same as or different from a weight for an intra part obtained based on an intra prediction mode indicated in the bitstream.

Clause 33. The method of any of clauses 1-24, wherein determining the prediction or the reconstruction of the current video block comprises: determining, based on the at least one target intra prediction mode, an intra part for the prediction or the reconstruction of the current video block; determining, based on the inter coding tool or the candidate coding tool, an inter part for the prediction or the reconstruction of the current video block; and determining the prediction or the reconstruction by weighting the intra part and the inter part with a first weight for the intra prat and a second weight for the inter part, at least one of the first weight or the second weight being pre-defined or indicated in the bitstream.

Clause 34. The method of any of clauses 1-33, wherein the at least one target intra prediction mode is determined from a first set of candidate intra prediction modes, and the first set of candidate intra prediction modes are the same as or different from a second set of candidate intra prediction modes for intra prediction of an intra-coded video unit.

Clause 35. The method of clause 34, wherein a number of candidate intra prediction modes in the first set of candidate intra prediction modes is less than a number of candidate intra prediction modes in the second set of candidate intra prediction modes.

Clause 36. The method of any of clauses 34-35, wherein the first set of candidate intra prediction modes are determined based on coding information of the video.

Clause 37. The method of clause 36, wherein the coding information comprises at least one of: a dimension of the current video unit, a size of the current video unit, a dimension of a current picture associate with the current video unit, a size of the current picture, a dimension of at least one adjacent video unit of the current video unit, a size of the at least one adjacent video unit, a dimension of at least one non-adjacent video unit of the current video unit, a size of the at least one non-adjacent video unit. a coding mode of the current video unit, a coding mode of the adjacent video unit, or a coding mode of the non-adjacent video unit.

Clause 38. The method of any of clauses 1-37, wherein at least one of the following is indicated in the bitstream: whether to enable the combination of the at least one target intra prediction mode and one of the inter coding tool or the candidate coding tool, or how to enable the combination of the at least one target intra prediction mode and one of the inter coding tool or the candidate coding tool.

Clause 39. The method of clause 28, wherein at least one syntax element is used to indicate whether the combination of the at least one target intra prediction mode and one of the inter coding tool or the candidate coding tool is enabled.

Clause 40. The method of clause 39, wherein whether the combination of the at least one target intra prediction mode and one of the inter coding tool or the candidate coding tool is enabled is indicated in the bitstream based on at least one of: whether the at least one target intra prediction mode intra prediction modes can be determined, whether the inter coding tool or the candidate coding tool is allowed, a dimension of the current video block, a size of the current video block, a depth of the current video block, a type of a current slice associated with the current video block, a type of a current picture associated with the current video block, a partition tree type associated with the current video block, a location of the current video block, or a color component of the current video block.

Clause 41. The method of any of clauses 39-40, wherein the at least one syntax element is included in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 42. The method of any of clauses 1-31, wherein whether the combination of the at least one target intra prediction mode and one of the inter coding tool or the candidate coding tool is allowed is dependent on at least one syntax element.

Clause 43. The method of any of clauses 1-37, wherein at least one of the following is determined based on coding information of the video: whether to enable the combination of the at least one target intra prediction mode and one of the inter coding tool or the candidate coding tool, or how to enable the combination of the at least one target intra prediction mode and one of the inter coding tool or the candidate coding tool.

Clause 44. The method of any of clauses 1-43, wherein the at least one target intra prediction mode is determined based on a first determination process, and the first determination process is the same as or different from a second determination process for determining intra prediction modes for an intra-coded video unit.

Clause 45. The method of any of clauses 1-44, wherein determining the prediction or the reconstruction of the current video block comprises: determining a predicted signal based at least on one of the at least one target intra prediction modes and a first process, the first process being the same as or different from a second process for determining a predicted signal based on an intra prediction mode indicated in the bitstream, and determining the prediction or the reconstruction of the current video block based on the predicted signal.

Clause 46. The method of clause 45, wherein at least one reference samples in the first process are filtered or unfiltered.

Clause 47. The method of any of clauses 45-46, wherein a filter for filtering a reference sample in the first process is different from a filer for filtering a reference sample in the second process.

Clause 48. The method of any of clauses 45-47, wherein the first process is performed without at least one of: position dependent prediction combination (PDPC), or gradient PDPC.

Clause 49. The method of any of clauses 45-48, wherein an intra interpolation filter used in the first process is different from an intra interpolation filter used in the second process.

Clause 50. The method of any of clauses 1-49, wherein the candidate coding tool comprises intra block copy (IBC).

Clause 51. The method of any of clauses 1-50, wherein the combination of the at least one target intra prediction mode and one of the inter coding tool or the candidate coding tool is dependent on a color component of the current video block.

Clause 52. The method of clause 51, wherein a target intra prediction mode determined for a first color component is different from a target intra prediction mode determined for a second color component different from the first color component.

Clause 53. The method of clause 51, wherein a target intra prediction mode is determined for a first color component and a pre-defined intra prediction mode is used for a second color component different from the first color component.

Clause 54. The method of clause 53, wherein the predefined intra prediction mode comprises at least one of: a planar mode, a DC mode, or a direct mode.

Clause 55. The method of any of clauses 53-54, wherein the current video block is coded in YCbCr color format, the YCbCr color format comprises a luma component, a first chroma component and a second chroma component different from the first chroma component, the first color component is the luma component, and the second color component is the first chroma component or the second chroma component.

Clause 56. The method of any of clauses 53-54, wherein the current video block is coded in YCbCr color format, the YCbCr color format comprises a luma component, a first chroma component and a second chroma component different from the first chroma component, the first color component is the first chroma component, and the second color component is the luma component or the second chroma component.

Clause 57. The method of any of clauses 53-54, wherein the current video block is coded in RGB color format, the RGB color format comprises a red component, a green component and a blue component, the first color component is the green component, and the second color component is the red component or the blue component.

Clause 58. The method of any of clauses 53-54, wherein the current video block is coded in RGB color format, the RGB color format comprises a red component, a green component and a blue component, the first color component is the red component, and the second color component is the green component or the blue component.

Clause 59. The method of any of clauses 53-54, wherein the current video block is coded in RGB color format, the RGB color format comprises a blue component, a green component and a blue component, the first color component is the red component, and the second color component is the green component or the red component.

Clause 60. The method of clause 51, wherein the combination of the at least one target intra prediction mode and one of the inter coding tool or the candidate coding tool is disabled for a first color component of the current video block, and determining the prediction of the current video block comprises: determining a prediction for the first color component based on one of: the at least one target intra prediction mode, the inter coding tool, or the candidate coding tool.

Clause 61. The method of any of clauses 1-6, wherein determining the reconstruction of the current video block comprises: determining a first candidate reconstruction of the current video block based on the at least one target intra prediction mode; determining a second candidate reconstruction of the current video block based on one of the inter coding tool or the candidate coding tool; and determining the reconstruction of the current video block based on the first candidate reconstruction and the second candidate reconstruction.

Clause 62. The method of any of clauses 1-61, wherein whether to and/or how to apply the method is indicated at one of: sequence level, group of pictures level, picture level, slice level, or tile group level.

Clause 63. The method of any of clauses 1-61, wherein whether to and/or how to apply the method is indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 64. The method of any of clauses 1-61, wherein whether to and/or how to apply the method is indicated at one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 65. The method of any of clauses 1-61, further comprising: determining, based on coded information of the current video unit, whether to and/or how to apply the method, the coded information comprising at least one of: a block size, a colour format, a single dual tree partitioning, a dual tree partitioning, a colour component, a slice type, or a picture type.

Clause 66. The method of any of clauses 1-65, wherein the conversion includes encoding the current video block into the bitstream.

Clause 67. The method of any of clauses 1-65, wherein the conversion includes decoding the current video block from the bitstream.

Clause 68. An apparatus for processing video data comprising a processor and a non-transitory memory with instructions thereon, wherein the instructions upon execution by the processor, cause the processor to perform a method in accordance with any of Clauses 1-67.

Clause 69. A non-transitory computer-readable storage medium storing instructions that cause a processor to perform a method in accordance with any of Clauses 1-67.

Clause 70. A non-transitory computer-readable recording medium storing a bitstream of a video which is generated by a method performed by a video processing apparatus, wherein the method comprises: determining at least one target intra prediction mode for a current video block of the video based on neighboring reconstructed samples of the current video block; determining a prediction or a reconstruction of the current video block based on a combination of the at least one target intra prediction mode and one of an inter coding tool or a candidate coding tool, the candidate coding tool being used for determining a reference block for the current video block with samples in a current picture associated with the current video block; and generating the bitstream based on the prediction or the reconstruction of the current video.

Clause 71. A method for storing a bitstream of a video, comprising: determining at least one target intra prediction mode for a current video block of the video based on neighboring reconstructed samples of the current video block; determining a prediction or a reconstruction of the current video block based on a combination of the at least one target intra prediction mode and one of an inter coding tool or a candidate coding tool, the candidate coding tool being used for determining a reference block for the current video block with samples in a current picture associated with the current video block; generating the bitstream based on the prediction or the reconstruction of the current video; and storing the bitstream in a non-transitory computer-readable recording medium.

### Example Device

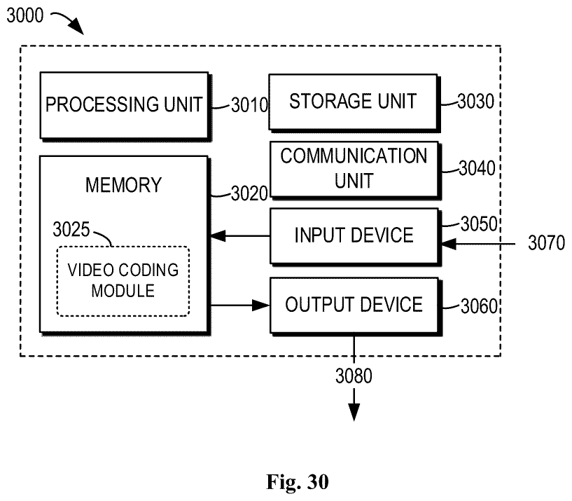

FIG. 30 illustrates a block diagram of a computing device 3000 in which various embodiments of the present disclosure can be implemented. The computing device 3000 may be implemented as or included in the source device 110 (or the video encoder 114 or 200) or the destination device 120 (or the video decoder 124 or 300).

It would be appreciated that the computing device 3000 shown in FIG. 30 is merely for purpose of illustration, without suggesting any limitation to the functions and scopes of the embodiments of the present disclosure in any manner.

As shown in FIG. 30, the computing device 3000 includes a general-purpose computing device 3000. The computing device 3000 may at least comprise one or more processors or processing units 3010, a memory 3020, a storage unit 3030, one or more communication units 3040, one or more input devices 3050, and one or more output devices 3060.

In some embodiments, the computing device 3000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3000 can support any type of interface to a user (such as “wearable” circuitry and the like).

The processing unit 3010 may be a physical or virtual processor and can implement various processes based on programs stored in the memory 3020. In a multi-processor system, multiple processing units execute computer executable instructions in parallel so as to improve the parallel processing capability of the computing device 3000. The processing unit 3010 may also be referred to as a central processing unit (CPU), a microprocessor, a controller or a microcontroller.

The computing device 3000 typically includes various computer storage medium. Such medium can be any medium accessible by the computing device 3000, including, but not limited to, volatile and non-volatile medium, or detachable and non-detachable medium. The memory 3020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3030 may be any detachable or non-detachable medium and may include a machine-readable medium such as a memory, flash memory drive, magnetic disk or another other media, which can be used for storing information and/or data and can be accessed in the computing device 3000.

The computing device 3000 may further include additional detachable/non-detachable, volatile/non-volatile memory medium. Although not shown in FIG. 30, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 3040 communicates with a further computing device via the communication medium. In addition, the functions of the components in the computing device 3000 can be implemented by a single computing cluster or multiple computing machines that can communicate via communication connections. Therefore, the computing device 3000 can operate in a networked environment using a logical connection with one or more other servers, networked personal computers (PCs) or further general network nodes.

The input device 3050 may be one or more of a variety of input devices, such as a mouse, keyboard, tracking ball, voice-input device, and the like. The output device 3060 may be one or more of a variety of output devices, such as a display, loudspeaker, printer, and the like. By means of the communication unit 3040, the computing device 3000 can further communicate with one or more external devices (not shown) such as the storage devices and display device, with one or more devices enabling the user to interact with the computing device 3000, or any devices (such as a network card, a modem and the like) enabling the computing device 3000 to communicate with one or more other computing devices, if required. Such communication can be performed via input/output (I/O) interfaces (not shown).

In some embodiments, instead of being integrated in a single device, some or all components of the computing device 3000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3000 may be used to implement video encoding/decoding in embodiments of the present disclosure. The memory 3020 may include one or more video coding modules 3025 having one or more program instructions. These modules are accessible and executable by the processing unit 3010 to perform the functionalities of the various embodiments described herein.

In the example embodiments of performing video encoding, the input device 3050 may receive video data as an input 3070 to be encoded. The video data may be processed, for example, by the video coding module 3025, to generate an encoded bitstream. The encoded bitstream may be provided via the output device 3060 as an output 3080.

In the example embodiments of performing video decoding, the input device 3050 may receive an encoded bitstream as the input 3070. The encoded bitstream may be processed, for example, by the video coding module 3025, to generate decoded video data. The decoded video data may be provided via the output device 3060 as the output 3080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, during a conversion between a current video block of a video and a bitstream of the video, at least one target intra prediction mode for the current video block based on neighboring reconstructed samples of the current video block;
determining a prediction or a reconstruction of the current video block based on a combination of the at least one target intra prediction mode and one of an inter coding tool or a candidate coding tool, the candidate coding tool being used for determining a reference block for the current video block with samples in a current picture associated with the current video block; and
performing the conversion based on the prediction or the reconstruction of the current video.

2. The method of claim 1, wherein the neighboring reconstructed samples comprise at least one of:
reconstructed samples adjacent to the current video block, or
reconstructed samples non-adjacent to the current video block, or
wherein determining the at least one target intra prediction mode comprises: determining the at least one target intra prediction mode by using at least one of:
decoder-side intra mode derivation (DIMD), or
template-based intra mode derivation (TIMD), or
wherein the at least one target intra prediction mode is determined from a plurality of coding tools for determining an intra prediction mode, or
wherein the inter coding tool comprises a target coding tool for determining the prediction or the reconstruction of the current video based on a plurality of predicted signals.

3. The method of claim 2, wherein the target coding tool comprises at least one of:
combined inter and intra prediction (CIIP),
a first coding tool for splitting the current video unit into multiple sub-partitions for prediction, or
a second coding tool for combing different predicted signals to obtain the prediction of the current video unit.

4. The method of claim 3, wherein the first coding tool comprises a geometric partitioning mode (GPM) or a triangle partition mode (TPM), or the second coding tool comprises a multiple hypothesis prediction (MHP), or
wherein the target coding tool comprises the CIIP, and an intra predicted signal is obtained based on the at least one target intra prediction mode and/or at least one predefined intra prediction mode.

5. The method of claim 4, wherein the at least one predefined intra prediction mode comprises a planar mode, or
wherein the combination of the at least one target intra prediction mode and one of the inter coding tool or the candidate coding tool is used in addition to CIIP.

6. The method of claim 3, wherein the target coding tool comprises the first coding tool, and a prediction of at least one target sub-partition of the multiple sub-partitions is determined based on the at least one target intra prediction mode, or
wherein the target coding tool comprises the second coding tool, and at least one predicted signal is determined based on the at least one target intra prediction mode.

7. The method of claim 6, wherein the at least one predicted signal is assigned with a predefined order of iteration for determining the prediction of the current video block, or
wherein determining the prediction of the current video block comprises: determining the prediction of the current video block by weighting all of candidate predicted signals for the current video block, the candidate predicted signals comprising one of the at least one predicted signal, or
wherein determining the prediction of the current video block comprises:
obtaining a weighted predicted signal by weighting one of the at least one predicted signal and one of a plurality of candidate predicted signals for the current video block; and
determining the prediction of the current video block based on the weighted predicted signal and remaining ones of the plurality of candidate predicted signals, or
wherein the target coding tool further comprises at least one of the CIIP or the first coding tool.

8. The method of claim 1, wherein the at least one target intra prediction mode comprises a plurality of target intra prediction modes.

9. The method of claim 8, wherein determining the prediction or the reconstruction of the current video block comprises:
determining a predicted signal based on one of the plurality of target intra prediction modes; and
determining the prediction or the reconstruction of the current video block based on the predicted signal.

10. The method of claim 9, wherein determining the prediction or the reconstruction of the current video block comprises:
determining multiple predicted signals based on at least two of the plurality of target intra prediction modes;
obtaining a weighted signal by weighting the multiple predicted signals; and
determining the prediction or the reconstruction of the current video block based on the weighted signal, or
wherein determining the prediction or the reconstruction of the current video block comprises:
determining predicted signals based on a set of intra prediction modes, the set of intra prediction modes comprising a predefined intra prediction mode and at least one of the plurality of target intra prediction modes;
obtaining a weighted signal by weighting the predicted signals; and
determining the prediction or the reconstruction of the current video block based on the weighted signal.

11. The method of claim 1, wherein determining the prediction or the reconstruction of the current video block comprises:
determining, based on the at least one target intra prediction mode, an intra part for the prediction or the reconstruction of the current video block;
determining, based on the inter coding tool or the candidate coding tool, an inter part for the prediction or the reconstruction of the current video block; and
determining the prediction or the reconstruction by weighting the intra part and the inter part with a first weight for the intra prat and a second weight for the inter part, at least one of the first weight or the second weight being dependent on coding information of the video, or
wherein determining the prediction or the reconstruction of the current video block comprises:
determining, based on the at least one target intra prediction mode, an intra part for the prediction or the reconstruction of the current video block;
determining, based on the inter coding tool or the candidate coding tool, an inter part for the prediction or the reconstruction of the current video block; and
determining the prediction or the reconstruction by weighting the intra part and the inter part with a first weight for the intra prat and a second weight for the inter part, at least one of the first weight or the second weight being dependent on coding mode of a neighboring video unit of the current video unit, or
wherein determining the prediction or the reconstruction of the current video block comprises:
determining, based on the at least one target intra prediction mode, an intra part for the prediction or the reconstruction of the current video block;
determining, based on the inter coding tool or the candidate coding tool, an inter part for the prediction or the reconstruction of the current video block; and
determining the prediction or the reconstruction by weighting the intra part and the inter part with a first weight for the intra prat and a second weight for the inter part, at least one of the first weight or the second weight being dependent on a variable obtained during the determination of the at least one target intra prediction mode, or
wherein determining the prediction or the reconstruction of the current video block comprises:
determining, based on the at least one target intra prediction mode, an intra part for the prediction or the reconstruction of the current video block;
determining, based on the inter coding tool or the candidate coding tool, an inter part for the prediction or the reconstruction of the current video block; and
determining the prediction or the reconstruction by weighting the intra part and the inter part with a first weight for the intra prat and a second weight for the inter part, at least one of the first weight or the second weight being pre-defined or indicated in the bitstream, or
wherein the at least one target intra prediction mode is determined from a first set of candidate intra prediction modes, and the first set of candidate intra prediction modes are the same as or different from a second set of candidate intra prediction modes for intra prediction of an intra-coded video unit.

12. The method of claim 11, wherein a number of candidate intra prediction modes in the first set of candidate intra prediction modes is less than a number of candidate intra prediction modes in the second set of candidate intra prediction modes, or
wherein the first set of candidate intra prediction modes are determined based on coding information of the video.

13. The method of claim 12, wherein the coding information comprises at least one of:
a dimension of the current video unit,
a size of the current video unit,
a dimension of a current picture associate with the current video unit,
a size of the current picture,
a dimension of at least one adjacent video unit of the current video unit,
a size of the at least one adjacent video unit,
a dimension of at least one non-adjacent video unit of the current video unit,
a size of the at least one non-adjacent video unit,
a coding mode of the current video unit,
a coding mode of the adjacent video unit, or
a coding mode of the non-adjacent video unit.

14. The method of claim 1, wherein at least one of the following is indicated in the bitstream:
whether to enable the combination of the at least one target intra prediction mode and one of the inter coding tool or the candidate coding tool, or
how to enable the combination of the at least one target intra prediction mode and one of the inter coding tool or the candidate coding tool.

15. The method of claim 11, wherein at least one syntax element is used to indicate whether the combination of the at least one target intra prediction mode and one of the inter coding tool or the candidate coding tool is enabled.

16. The method of claim 15, wherein whether the combination of the at least one target intra prediction mode and one of the inter coding tool or the candidate coding tool is enabled is indicated in the bitstream based on at least one of:
whether the at least one target intra prediction mode intra prediction modes can be determined,
whether the inter coding tool or the candidate coding tool is allowed,
a dimension of the current video block,
a size of the current video block,
a depth of the current video block,
a type of a current slice associated with the current video block,
a type of a current picture associated with the current video block,
a partition tree type associated with the current video block,
a location of the current video block, or
a color component of the current video block, or
wherein the at least one syntax element is included in one of:
a sequence header,
a picture header,
a sequence parameter set (SPS),
a video parameter set (VPS),
a dependency parameter set (DPS),
a decoding capability information (DCI),
a picture parameter set (PPS),
an adaptation parameter sets (APS),
a slice header, or
a tile group header.

17. The method of claim 1, wherein whether the combination of the at least one target intra prediction mode and one of the inter coding tool or the candidate coding tool is allowed is dependent on at least one syntax element, or
wherein at least one of the following is determined based on coding information of the video:
whether to enable the combination of the at least one target intra prediction mode and one of the inter coding tool or the candidate coding tool, or
how to enable the combination of the at least one target intra prediction mode and one of the inter coding tool or the candidate coding tool, or
wherein the at least one target intra prediction mode is determined based on a first determination process, and the first determination process is the same as or different from a second determination process for determining intra prediction modes for an intra-coded video unit, or
wherein determining the prediction or the reconstruction of the current video block comprises:
determining a predicted signal based at least on one of the at least one target intra prediction modes and a first process, the first process being the same as or different from a second process for determining a predicted signal based on an intra prediction mode indicated in the bitstream, and
determining the prediction or the reconstruction of the current video block based on the predicted signal.

18. The method of claim 1, wherein the candidate coding tool comprises intra block copy (IBC), or
wherein the combination of the at least one target intra prediction mode and one of the inter coding tool or the candidate coding tool is dependent on a color component of the current video block, or
wherein determining the reconstruction of the current video block comprises:
determining a first candidate reconstruction of the current video block based on the at least one target intra prediction mode;
determining a second candidate reconstruction of the current video block based on one of the inter coding tool or the candidate coding tool; and
determining the reconstruction of the current video block based on the first candidate reconstruction and the second candidate reconstruction, or
wherein whether to and/or how to apply the method is indicated at one of:
sequence level,
group of pictures level,
picture level,
slice level, or
tile group level, or
wherein whether to and/or how to apply the method is indicated in one of:
a sequence header,
a picture header,
a sequence parameter set (SPS),
a video parameter set (VPS),
a dependency parameter set (DPS),
a decoding capability information (DCI),
a picture parameter set (PPS),
an adaptation parameter sets (APS),
a slice header, or
a tile group header, or
wherein whether to and/or how to apply the method is indicated at one of:
a prediction block (PB),
a transform block (TB),
a coding block (CB),
a prediction unit (PU),
a transform unit (TU),
a coding unit (CU),
a virtual pipeline data unit (VPDU),
a coding tree unit (CTU),
a CTU row,
a slice,
a tile,
a sub-picture, or
a region containing more than one sample or pixel, or
wherein the method further comprises:
determining, based on coded information of the current video unit, whether to and/or how to apply the method, the coded information comprising at least one of:
a block size,
a colour format,
a single dual tree partitioning,
a dual tree partitioning,
a colour component,
a slice type, or
a picture type, or
wherein the conversion includes encoding the current video block into the bitstream or wherein the conversion includes decoding the current video block from the bitstream.

19. An apparatus for processing video data comprising a processor and a non-transitory memory with instructions thereon, wherein the instructions upon execution by the processor, cause the processor to perform acts comprising:
determining, during a conversion between a current video block of a video and a bitstream of the video, at least one target intra prediction mode for the current video block based on neighboring reconstructed samples of the current video block;
determining a prediction or a reconstruction of the current video block based on a combination of the at least one target intra prediction mode and one of an inter coding tool or a candidate coding tool, the candidate coding tool being used for determining a reference block for the current video block with samples in a current picture associated with the current video block; and
performing the conversion based on the prediction or the reconstruction of the current video.

20. A non-transitory computer-readable storage medium storing instructions that cause a processor to perform acts comprising:
determining, during a conversion between a current video block of a video and a bitstream of the video, at least one target intra prediction mode for the current video block based on neighboring reconstructed samples of the current video block;
determining a prediction or a reconstruction of the current video block based on a combination of the at least one target intra prediction mode and one of an inter coding tool or a candidate coding tool, the candidate coding tool being used for determining a reference block for the current video block with samples in a current picture associated with the current video block; and
performing the conversion based on the prediction or the reconstruction of the current video.
